(19) United States
(12) Patent Application Publication
(10) Pub. No.: US 2020/0056079 A1
(43) Pub. Date: Feb. 20, 2020

(54) ANTIFOULING ARTICLE AND METHOD FOR PRODUCING ANTIFOULING ARTICLE

(71) Applicant: AGC Inc., Chiyoda-ku (JP)

(72) Inventors: Tamami Takeuchi, Chiyoda-ku (JP); Ayumu Suzuki, Chiyoda-ku (JP); Yoshihiko Sakane, Chiyoda-ku (JP)

(73) Assignee: AGC Inc., Chiyoda-ku (JP)

(21) Appl. No.: 16/665,006

(22) Filed: Oct. 28, 2019

Related U.S. Application Data
(63) Continuation of application No. PCT/JP2018/017907, filed on May 9, 2018.

(30) Foreign Application Priority Data
May 12, 2017 (JP) 2017-095747

(51) Int. Cl. C09K 3/18; C08J 7/06

(52) U.S. Cl. CPC C09K 3/18; C08J 7/065; C08J 2367/02; C08J 2369/00; C08J 2333/12

(57) ABSTRACT

To provide an antifouling article having an antifouling layer formed on the surface of an organic material using a fluorinated compound, wherein the antifouling article is excellent in antifouling properties and has durability such as abrasion resistance with respect to the antifouling properties.

An antifouling article comprising:
a substrate, at least a portion of the surface thereof being made of an organic material;
a primer layer disposed on the surface made of the organic material; and
an antifouling layer disposed on the primer layer; wherein:
the primer layer is a layer formed by using a first silane compound which has a hydrolyzable silyl group, and a reactive organic group (a reactive organic group (A)) that is a group having a linking group and a reactive group, or a reactive group other than a hydrolyzable group;
the absolute value of the difference between the SP value of the organic material and the SP value of the reactive organic group is from 0 to 3.0 (J/cm³)^{1/2}; and
the antifouling layer is a layer formed by using a second silane compound having a perfluoropolyether group and a hydrolyzable silyl group.

### TECHNICAL FIELD

The present invention relates to an antifouling article and a method for producing an antifouling article.

### BACKGROUND ART

In order to impart water- and oil-repellent properties to the surfaces of various substrates, known is an antifouling article having an improved antifouling property, i.e. a property to suppress the adhesion of fouling and to facilitate the removal of the adhered fouling, which is provided by having a coating with low surface tension on the surface of the substrate.

A fluorinated compound has been conventionally used for a coating composition for obtaining a coating having the above-mentioned antifouling property. For example, a fluorinated silane compound having at least one fluorinated group (e.g., a perfluoroalkyl group, a perfluoroether group, and a perfluoropolyether group) has been used for a coating composition for imparting oil-repellency and/or water-repellency to the surface of a substrate made of an inorganic material such as glass or ceramic (see e.g. Patent Documents 1 to 4).

### PRIOR ART DOCUMENTS

### Patent Documents

Patent Document 1: U.S. Pat. No. 3,950,588

Patent Document 2: U.S. Pat. No. 7,335,786

Patent Document 3: U.S. Pat. No. 7,745,653

Patent Document 4: U.S. Patent Application Publication No. 2010/0167978

### DISCLOSURE OF INVENTION

### Technical Problem

However, in an antifouling article in which an antifouling coating (antifouling layer) is provided on the surface of a substrate by using a fluorinated silane compound, particularly in a case where at least a portion of the surface of the substrate is made of an organic material such as a resin, the repetition of washing and rubbing the surface of the antifouling layer may lower the antifouling property.

The present invention has been made from the above point of view. It is an object of the present invention to provide an antifouling article comprising an antifouling layer formed on the surface of an organic material by using a fluorinated compound wherein the antifouling article is excellent in the antifouling property and has durability such as abrasion resistance with respect to the antifouling property. It is a further object of the present invention to provide a method for manufacturing an antifouling article comprising an antifouling layer formed on the surface of an organic material by using a fluorinated compound wherein the antifouling article is excellent in the antifouling property and has durability such as abrasion resistance with respect to the antifouling property.

### Solution to Problem

The gist of the present invention is as follows.

[1] An antifouling article comprising:

a substrate, at least a portion of the surface thereof being made of an organic material;

a primer layer disposed on the surface made of the organic material; and

an antifouling layer disposed on the primer layer; wherein:

the primer layer is a layer formed by using a first silane compound which has a hydrolyzable silyl group and a reactive organic group;

the reactive organic group is a group having a linking group and a reactive group, or a reactive group other than a hydrolyzable group;

the absolute value of the difference between the SP value of the organic material and the SP value of the reactive organic group is from 0 to 3.0 (J/cm³)^{1/2}; and

the antifouling layer is a layer formed by using a second silane compound having a perfluoropolyether group and a hydrolyzable silyl group.

[2] The antifouling article according to [1], wherein the thickness of the primer layer is from 5 to 100 nm.
[3] The antifouling article according to [1] or [2], wherein the thickness of the antifouling layer is from 10 to 100 nm.
[4] The antifouling article according to any one of [1] to [3], wherein the reactive organic group is a group having at least one reactive group selected from a vinyl group, an epoxy group, a (meth)acryloxy group, an amino group, an isocyanate group, and a mercapto group.
[5] The antifouling article according to any one of [1] to [4], wherein the first silane compound is at least one member selected from 3-aminopropyltriethoxysilane, 3-methacryloxypropyltrimethoxysilane, and 3-glycidoxypropyltrimethoxysilane.
[6] The antifouling article according to any one of [1] to [5], wherein the second silane compound is a silane compound which has a poly(oxyperfluoroalkylene) chain represented by —(CₐF₂ₐO)_{b}— (wherein a is an integer of from 1 to 6, b is an integer of at least 2, and it may have at least two —CₐF₂ₐO— units different in the number of carbon atoms), and which has a hydrolyzable silyl group via a linking group at at least one end of the poly(oxyperfluoroalkylene) chain.
[7] The antifouling article according to any one of [1] to [6], wherein the organic material contains at least one member selected from a resin and an elastomer.
[8] A method for producing an antifouling article comprising:

a substrate, at least a portion of the surface thereof being made of an organic material;

a primer layer disposed on the surface made of the organic material; and

an antifouling layer disposed on the primer layer;

wherein the method comprises:

applying, onto the surface made of the organic material, a composition for primer layer comprising a first silane compound and a first solvent, wherein the first silane compound has a hydrolyzable silyl group and a reactive organic group; the reactive organic group is a group having a linking group and a reactive group, or a reactive group other than a hydrolyzable group; and the absolute value of the difference between the SP value of the organic material and the SP value of the reactive organic group is from 0 to 3.0 (J/cm³)^{1/2}; and then reacting the first silane compound to obtain the primer layer; and

depositing, on the primer layer, a composition for antifouling layer comprising a second silane compound having a perfluoropolyether group and a hydrolyzable silyl group; and then reacting the second silane compound to obtain the antifouling layer.

[9] The production method according to [8], wherein the absolute value of the difference between the SP value in the case where the hydrolyzable silyl group of the first silane compound is a silanol group and the SP value of the first solvent is from 0 to 12.0 (J/cm3)^{1/2}.
[10] The production method according to [8] or [9], wherein the absolute value of the difference between the SP value of the first solvent and the SP value of the organic material is from 0 to 5.0 (J/cm³)^{1/2}.
[11] The production method according to any one of [8] to [10], wherein the composition for primer layer is applied so that the applied amount of the first silane compound be from 1.0 to 4.0 mg/m².
[12] The production method according to any one of [8] to [11], wherein the first silane compound is contained in a proportion of from 0.01 to 5.0 mass % to the total amount of the composition for primer layer.
[13] The production method according to any one of [8] to [12], wherein the reactive organic group is a group having at least one reactive group selected from a vinyl group, an epoxy group, a (meth)acryloxy group, an amino group, an isocyanate group, and a mercapto group.
[14] The production method according to any one of [8] to [13], wherein the first silane compound is at least one member selected from 3-aminopropyltriethoxysilane, 3-methacryloxypropyltrimethoxysilane and 3-glycidoxypropyltrimethoxysilane.
[15] The production method according to any one of [8] to [14], wherein the second silane compound is a silane compound which has a poly(oxyperfluoroalkylene) chain represented by —(CₐF₂ₐO)_{b}— (wherein a is an integer of from 1 to 6, b is an integer of at least 2, and it may have at least two —CₐF₂ₐO— units different in the number of carbon atoms), and which has a hydrolyzable silyl group via a linking group at at least one terminal of the poly(oxyperfluoroalkylene) chain.
[16] The production method according to any one of [8] to [15], wherein the composition for antifouling layer is deposited so that the deposited amount of the second silane compound be from 30 to 80 mg/m².
[17] The production method according to any one of [8] to [16], wherein the composition for antifouling layer further contains a second solvent, and the composition for antifouling layer is applied onto the primer layer.
[18] The production method according to [17], wherein the second silane compound is contained in a proportion of from 0.001 to 30 mass % to the total amount of the composition for antifouling layer.
[19] The production method according to any one of [8] to [18], wherein the organic material contains at least one member selected from a resin and an elastomer.

### Advantageous Effects of Invention

According to the antifouling article of the present invention, in the antifouling article comprising an antifouling layer formed on the surface of an organic material by using a fluorinated compound, the antifouling article is excellent in the antifouling property and is excellent in durability such as abrasion resistance with respect to the antifouling property.

According to the method for producing an antifouling article of the present invention, it is possible to produce the antifouling article which is excellent in the antifouling property and which is excellent in durability such as abrasion resistance with respect to the antifouling property.

### DESCRIPTION OF EMBODIMENTS

Hereinafter, embodiments to carry out the present invention will be explained. However, the present invention should not be construed as being limited to the following explanation.

In this specification, a compound or group represented by a formula is also represented as a compound or group to which the number of the formula is assigned. For example, a compound represented by the formula (1) is also represented by a compound (1).

In this specification, the term “(meth)acryloxy” is used as a generic term for acryloxy and methacryloxy. In this specification, the term “from . . . to . . . ” representing a numerical range encompasses the upper limit and the lower limit.

### Antifouling Article

The antifouling article of the present invention is an antifouling article comprising: a substrate, at least a portion of the surface thereof being made of an organic material; a primer layer disposed on the surface made of the organic material; and an antifouling layer disposed on the primer layer. The primer layer is formed on at least a portion of the surface made of the organic material, including a region where the antifouling layer is to be formed.

The primer layer is a layer formed by using a first silane compound which has a hydrolyzable silyl group and a reactive organic group. The reactive organic group is a group having a linking group and a reactive group, or a reactive group other than a hydrolyzable group. Hereinafter, the reactive organic group is also referred to as a “reactive organic group (A)”.

As to the reactive organic group (A), as stated above, the structure differs between a case where the reactive group is a hydrolyzable group and a case where the reactive group is a group other than a hydrolyzable group. In the case where the reactive group is a hydrolyzable group, the reactive organic group (A) is a group having a linking group and a hydrolyzable group. In the reactive organic group having a linking group and a hydrolyzable group, the linking group is bonded to a silicon atom, and the hydrolyzable reactive group can be chemically bonded to the surface of the organic material. The hydrolyzable group bonded to a silicon atom in the hydrolyzable silyl group is a group capable of forming a silanol group (Si—OH) by a hydrolysis reaction, while the reactive organic group having a linking group and a hydrolyzable group does not form a silanol group (Si—OH). In view of this, the reactive organic group having a linking group and a hydrolyzable group is different from the hydrolyzable group in the hydrolyzable silyl group.

In the reactive organic group (A), in a case where the reactive group is a group other than a hydrolyzable group, the reactive group itself may be a reactive organic group, and the reactive organic group may be constituted by a group having a linking group and a reactive group. That is, the reactive organic group having a reactive group other than a hydrolyzable group is a group in which the reactive group other than a hydrolyzable group is bonded to a silicon atom directly or through a linking group. In a case where the reactive group is a group other than a hydrolyzable group, the reactive group can be chemically bonded to the surface of the organic material.

If the SP value of the reactive organic group (A) in the first silane compound is represented by “SP_{fg}” and the SP value of the organic material constituting the surface on which the primer layer is to be formed is represented by “SPₒₘ”, the absolute value of the difference between the two represented by |SP_{fg}−SPₒₘ| is from 0 to 3.0 (J/cm³)^{1/2}. That is, the following formula (i) is satisfied.

|SP_{fg}−SPₒₘ|≤3.0 (J/cm³)^{1/2} (i)

The SP value of the reactive organic group (A) or the organic material is a cohesive energy density of the reactive organic group (A) or the organic material, i.e. a square root value of an evaporation energy per unit volume of one molecule (or one group in the case of a group), and is a numerical value to show the magnitude of the polarity per unit volume. The unit is (J/cm³)^{1/2}, and the SP value refers to a value at 25° C. in this specification, unless otherwise specified. The SP value can be calculated by a Fedros method (see R. F. Fedros, Polym. Eng. Sci., 14 (2) 147 (1974)).

The antifouling layer is a layer formed by using a second silane compound having a perfluoropolyether group and a hydrolyzable silyl group.

The hydrolyzable silyl group which the first silane compound and the second silane compound have is a group in which the hydrolyzable group is directly bonded to a silicon atom, and which is capable of forming a silanol group (Si—OH) by a hydrolysis reaction.

In the antifouling article of the present invention, as described below, when the primer layer is formed, a part or all of reactive organic groups (A) in the first silane compound is chemically bonded to the surface of the organic material of the substrate. It is considered that when |SP_{fg}−SPₒₘ| is within the above predetermined range, the affinity between the surface of the organic material and the reactive organic group (A) is increased, the chemical reaction is promoted, and the adhesion of the primer layer to the surface of the organic material is excellent. Furthermore, wettability of the first silane compound to the surface of the organic material is improved, and the primer layer can be uniformly formed.

|SP_{fg}−SPₒₘ| is preferably from 0 to 2.5 (J/cm³)^{1/2}, more preferably from 0 to 2.0 (J/cm³)^{1/2}, particularly preferably from 0 to 1.6 (J/cm³)^{1/2}, from the viewpoint of further excellent adhesion with the surface of the primer layer.

Further, when the primer layer is formed, silanol groups (Si—OH) are generated by hydrolyzing hydrolyzable silyl groups in the first silane compound, and then the silanol groups react intermolecularly to form Si—O—Si bonds. In addition, the silanol groups reacts with silanol groups generated from the hydrolyzable silyl group in the second silane compound used for forming the antifouling layer, thereby forming Si—O—Si bonds. As a result, it is considered that the primer layer and the antifouling layer are strongly bonded to each other.

The antifouling layer is formed by Si—O—Si bonds with the primer layer as described above, and in the antifouling layer, silanol groups generated from the hydrolyzable silyl group in the second silane compound react intermolecularly to form Si—O—Si bonds. On the other hand, perfluoropolyether groups in the second silane compound do not participate in the above reaction and exist in the surface of the antifouling layer, thereby producing the antifouling property.

Accordingly, in the antifouling article of the present invention, the primer layer contains a reaction product of the first silane compound in a state where a part or all of hydrolyzable silyl groups in the first silane compound are hydrolyzed and a part or all of reactive organic groups (A) are chemically reacted. Similarly, the antifouling layer contains a reaction product of the second silane compound in a state where a part or all of hydrolyzable silyl groups in the second silane compound are hydrolyzed. Incidentally, the reaction product of of the first silane compound may contain the first silane compound itself. That is, the reaction product of the first silane compound refers to the entire component derived from the first silane compound obtained after the reaction of the first silane compound. The same applies to the reaction product of the second silane compound.

Components of the antifouling article of the present invention will be described below.

### Substrate

The substrate is not particularly limited as long as at least a portion of the surface thereof is made of an organic material. The entire surface of the substrate may be made of an organic material, or a portion of the surface of the substrate may be made of an organic material. The surface of the substrate may be made of the same organic material, or may be made of different organic materials.

The substrate may, for example, be composed entirely of a single organic material, or may be a laminate in which a plurality of layers of organic material (hereinafter referred to as an “organic material layer”) are laminated. Further, it may be a laminate of an organic material layer and a layer made of an inorganic material (hereinafter referred to as an “inorganic material layer”), and at least one layer of the surface layers may be an organic material layer. In addition, a structure may be employed in which an inorganic material and an organic material are mixed and at least a portion of the surface is made of an organic material. The organic material layer which these laminates have on the surface layer may be a hard coat layer or the like provided to increase the hardness of the surface of the substrate.

The shape of the substrate is not particularly limited, and may be in the form of a plate, film (thin film), bar, or envelope. When the substrate has a plate shape, it may be a flat plate, or may have a shape in which a part or whole of the main surface has a curvature. In addition, the surface shape may be smooth or may have irregularities.

In this specification, an organic material is meant for a material that contains at least 10 mass % of an organic substance with respect to the entire material. The organic material may be composed of, for example, only an organic substance, or may be an organic-inorganic composite material containing an organic substance in the above range in which the organic substance and an inorganic substance are mixed.

In the substrate, the organic material constituting the surface on which the primer layer is to be formed contains, for example, at least one member selected from a resin and an elastomer.

The resin may specifically be a polyester resin such as polyethylene terephthalate (PET) or polybutylene terephthalate; a polyolefin resin such as polyethylene (PE) or polypropylene (PP); an ethylene vinyl acetate copolymer (EVA); a vinyl acetate resin; a norbornene resin; an acrylic resin such as polyacrylate or polymethyl methacrylate (PMMA); a urethane resin; a polyarylate resin; an acrylic urethane resin; a vinyl chloride resin; a vinylidene chloride resin; a fluororesin; a polycarbonate resin (PC); a polyvinyl butyral resin; a polyvinyl alcohol resin (PVA); a polymethacrylimide resin; a polystyrene resin; an ABS resin; a MS (methyl methacrylate/styrene) resin; an epoxy resin; or the like.

The elastomer may be a thermosetting elastomer and a thermoplastic elastomer. The thermosetting elastomers may specifically be isobutylene rubber, isoprene rubber, butadiene rubber, styrene-butadiene rubber (SBR), ethylene-propylene rubber (EPDM rubber), silicone rubber, urethane rubber, or fluorine rubber. The thermoplastic elastomer may specifically be styrene-type, olefin-type, vinyl chloride-type, polyester-type, polyurethane-type, or nylon-type.

Here, the SP value (SPₒₘ) of the organic material constituting the surface on which the primer layer is to be formed is not particularly limited as long as the relation with the SP value (SP_{fg}) of the reactive organic group (A) in the first silane compound satisfies the above formula (i). However, the kind of the reactive organic group (A) in the first silane compound is limited to some extent, and SP_{fg} is generally limited to the following ranges. Therefore, SPₒₘ is preferably in the range of from 10.0 to 30.0 (J/cm³)^{1/2}, and more preferably in the range of from 14.0 to 25.0 (J/cm³)^{1/2}, in view of the relation with SP_{fg}.

The above resin and elastomer are commercially available. With respect to commercial products of typical organic materials, the SP values are shown in Table 1.

TABLE 1

| Organic material | SP value (J/cm³)^{1/2} |
|---|---|
| Silicone rubber | 14.3 |
| Isobutylene rubber | 15.9 |
| PE | 16.4 |
| PP | 16.6 |
| Butadiene rubber | 17.0 |
| SBR | 17.1 |
| Polystyrene resin | 18.7 |
| Vinyl acetate resin | 18.8 |
| Vinyl chloride resin | 19.0 |
| PMMA | 19.4 |
| PC | 20.2 |
| Urethane rubber | 20.5 |
| PET | 21.9 |
| Epoxy resin | 22.9 |
| Vinylidene chloride resin | 24.9 |

### Primer Layer

The primer layer is formed by using the first silane compound. The primer layer is configured to contain a reaction product of the first silane compound as described above. The primer layer may contain an optional component other than the reaction product of the first silane compound within a range not to impair the effect of the present invention. The proportion of the reaction product of the first silane compound to the entire primer layer is preferably from 80 to 100 mass %, more preferably from 95 to 100 mass %, from the viewpoint of further excellent adhesion between the antifouling layer and the primer layer and between the primer layer and the substrate.

The thickness of the primer layer is preferably a monomolecular thickness of the first silane compound since adhesion between the antifouling layer and the primer layer and between the primer layer and the substrate surface is excellent, and durability of the antifouling property of the antifouling article is excellent. If the thickness of the primer layer is too thick, the utilization efficiency is lowered. In addition, if the thickness of the primer layer is too thick, the primer layer becomes brittle and the durability decreases. The thickness of the primer layer is specifically preferably from 5 to 100 nm, more preferably from 5 to 10 nm. The thickness of the primary layer can be calculated by using, for example, a X-ray diffractometer for thin-film analysis (ATX-G, manufactured by RIGAKU). It can be calculated by obtaining the interference pattern of the reflected X-ray by a X-ray reflection method and then using the frequency of the interference pattern.

### First Silane Compound

The first silane compound is not particularly limited as long as the first silane compound is a compound having a hydrolyzable silyl group and a reactive organic group (A), and the SP value of the reactive organic group (A) satisfies the formula (i) in relation to the above SPₒₘ. Hereinafter, unless otherwise specified, a “hydrolyzable group” refers to a hydrolyzable group constituting a hydrolyzable silyl group.

The number of silicon atoms in the first silane compound is preferably from 1 to 3, more preferably from 1 to 2, particularly preferably 1, from the viewpoint of excellent reactivity with the second silane compound. The molecular weight of the first silane compound is preferably from 100 to 300, more preferably from 140 to 280, from the viewpoint of excellent compatibility with the diluent solvent.

The number of reactive organic groups (A) in the first silane compound is preferably from 1 to 2, more preferably 1, per one silicon atom. The number of hydrolyzable groups in the first silane compound is preferably from 1 to 3, more preferably 2 or 3, per one silicon atom. The first silane compound may have a non-reactive organic group that is bonded to a silicon atom, in addition to the reactive organic group (A) and the hydrolyzable group.

The first silane compound may be preferably a compound represented by the following formula (S1).

R¹¹_{d}SiL¹¹ₑR¹²_{4-d-e} (S1)

Here, the symbols in the formula (S1) are as follows.

R¹¹: reactive organic group (A)

R¹²: monovalent saturated hydrocarbon group

L¹¹: hydrolyzable group

d: 1 or 2

e: an integer of from 1 to 3

d+e: from 2 to 4

When a plurality of R¹¹, R¹², or L¹¹ are present, they may be the same or different from one another.

R¹¹ is a group having a linking group and a reactive group, or a reactive group other than a hydrolyzable group. That is, if a reactive group is classified into a hydrolyzable group and a reactive group other than a hydrolyzable group, R¹¹ is either a structure having a linking group and a hydrolyzable group, a structure having a linking group and a reactive group other than a hydrolyzable group, or a structure that is a reactive group other than a hydrolyzable group. The linking group means a group that bonds a silicon atom and a hydrolyzable group or a reactive group other than a hydrolyzable group. The hydrolyzable group is, for example, an alkoxy group, a halogen atom, an acyl group, an isocyanate group (—NCO), an amino group, or the like, and is preferably an amino group or an isocyanate group. Hereinafter, the hydrolyzable group and the reactive group other than a hydrolyzable group in R¹¹ are collectively referred to simply as the reactive group.

The reactive group in R¹¹ may specifically be a vinyl group, an epoxy group, a (meth)acryloxy group, an amino group, an isocyanate group, a mercapto group, or the like. Incidentally, in this specification, the amino group means —NHR¹³ (R¹³ is H or a monovalent hydrocarbon group). As the monovalent hydrocarbon group represented by R¹³, a C₁₋₃ alkyl group or an C₆₋₁₀ aryl group is preferred. When R¹¹ has an amino group or an isocyanate group as a reactive group, R¹¹ also has a linking group that bonds such a reactive group to a silicon atom.

The number of reactive groups in R¹¹ is preferably from 1 to 3, more preferably from 1 or 2, and particularly preferably 1. R¹¹ may have a reactive group at a side chain of the reactive organic group or at its terminal. From the viewpoint of reactivity with the organic material of the substrate, R¹¹ preferably has a reactive group at its terminal.

The number of carbon atoms in R¹¹ is preferably from 2 to 10, more preferably from 2 to 9. The preferred number of carbon atoms of R¹¹ differs depending on the reactive group. When the reactive group is a vinyl group, the preferred number of carbon atoms is from 2 to 4, more preferably 2. When the reactive group is a vinyl group and the number of carbon atoms in R¹¹ is 2, R¹¹ is a vinyl group (—CH═CH₂) per se.

When the reactive group is an epoxy group, a glycidyloxy group or an epoxycyclohexyl group is preferred as the reactive group containing an epoxy group. When R¹¹ has a reactive group at its terminal, the reactive group and the silicon atom are bonded via a linking group. As the linking group for bonding a glycidyloxy group or an epoxycyclohexyl group and a silicon atom, a C₁₋₆ alkylene group is preferred, and an ethylene group or a propylene group is particularly preferred.

When the reactive group is an amino group and R¹¹ has an amino group at its terminal, the reactive group and the silicon atom are bonded via a linking group. As the linking group for linking an amino group and a silicon atom, a C₁₋₁₀ alkylene group, which may have a nitrogen atom between carbon-carbon atoms, is preferred, and —(CH₂)_{2 or 3}—(NH—(CH₂)_{2 or 3}—, an ethylene group or a propylene group is particularly preferred.

When R¹¹ has the reactive group other than a vinyl group, an epoxy group or an amino group, it may have a linking group that bonds a reactive group and a silicon atom. When it has a linking group, a C₁₋₁₀ alkylene group is preferred, and an ethylene group or a propylene group is particularly preferred.

The SP value (SP_{fg}) of R¹¹ in the compound (S1) is not particularly limited as long as the relation with the SP value (SPₒₘ) of the organic material constituting the surface of the substrate on which the primer layer is to be formed satisfies the above formula (i). SP_{fg} depends on the type of the reactive group in R¹¹ and the linking group. SP_{fg} is in a range of preferably from 10.0 to 30.0 (J/cm³)^{1/2}, more preferably from 14.0 to 25.0 (J/cm³)^{1/2}, further preferably from 14.0 to 23.0 (J/cm³)^{1/2}. The SP values of the reactive organic group (A) that is preferred as R¹¹ are shown in Table 2.

TABLE 2

| Reactive organic group (A) | SP value (J/cm³)^{1/2} |
|---|---|
| Vinyl group | 14.4 |
| 2-(3,4-Epoxycyclohexyl) ethyl group | 19.2 |
| 3-Glycidoxypropyl group | 19.0 |
| 3-Methacryloxypropyl group | 19.4 |
| 3-Mercaptopropyl group | 19.6 |
| 3-Aminopropyl group | 20.3 |
| N-(2-Aminoethyl)-3-aminopropyl group | 21.0 |
| 3-Isocyanatopropyl group | 22.8 |

L¹¹ is a hydrolyzable group. The hydrolyzable group is a group which becomes a hydroxy group by a hydrolysis reaction. L¹¹ may specifically be an alkoxy group, a halogen atom, an acyl group, an isocyanate group (—NCO), an amino group, or the like. As the alkoxy group, a C₁₋₅ alkoxy group is preferred. As the halogen atom, a chlorine atom is preferred.

Among these, L¹¹ may be preferably a C₁₋₄ alkoxy group, particularly preferably a methoxy group or an ethoxy group. The number of hydrolyzable groups bonded to silicon atoms is preferably two or three. Two or three of the hydrolyzable groups may be the same or different, but are preferably the same from the viewpoint of productivity.

R¹² is a monovalent saturated hydrocarbon group. The monovalent saturated hydrocarbon group may be a straight chain or may contain a branched or ring structure. The number of carbon atoms in R¹² is preferably from 1 to 6, more preferably from 1 to 4. R¹² is more preferably a methyl group or an ethyl group, particularly preferably a methyl group.

Specific examples of the compound (S1) may be as follows.

The compound (S1) having a vinyl group as the reactive group may be vinyldimethylmonomethoxysilane, vinyldimethylmonoethoxysilane, vinylmethyldimethoxysilane, vinylmethyldiethoxysilane, vinyltrimethoxysilane, vinyltriethoxysilane, N-2-(N-vinylbenzylaminoethyl)-3-aminopropyltrimethoxysilane, or the like.

The compound (S1) having an epoxy group as the reactive group may be 2-(3,4-epoxycyclohexyl)ethyltrimethoxysilane, 3-glycidoxypropyltrimethoxysilane, 3-glycidoxypropyltriethoxysilane, 3-glycidoxypropylmethyldimethoxysilane, 3-glycidoxypropylmethyldiethoxysilane, or the like.

The compound (S1) having a (meth)acryloxy group as the reactive group may be 3-methacryloxypropyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane.

The compound (S1) having an amino group as the reactive group may be N-(2-aminoethyl)-3-aminopropylmethyldimethoxysilane, N-(2-aminoethyl)-3-aminopropyltrimethoxysilane, N-(2-aminoethyl)-N′-(2-aminoethyl)-3-aminopropyltriethoxysilane, 3-aminopropyltrimethoxysilane, 3-aminopropyltriethoxysilane, 3-aminopropylmethyldimethoxysilane, 3-aminopropylmethyldiethoxysilane, N-phenyl-3-aminopropyltrimethoxysilane, or the like.

The compound (S1) having an isocyanate group or a mercapto group as the reactive group may be 3-isocyanatopropyltrimethoxysilane, 3-isocyanatopropyltriethoxysilane, 3-mercaptopropyltrimethoxysilane, 3-mercaptopropylmethyldimethoxysilane, or the like.

From the viewpoint of excellent reactivity with the second silane compound and excellent adhesion to the antifouling layer, the first silane compound is preferably at least one member selected from vinyltrimethoxysilane, 2-(3,4-epoxycyclohexyl) ethyltrimethoxysilane, 3-glycidoxypropyltrimethoxysilane, 3-methacryloxypropyl trimethoxysilane, 3-acryloxypropyltrimethoxysilane, N-(2-aminoethyl)-3-aminopropylmethyldimethoxysilane, 3-aminopropyltrimethoxysilane, 3-aminopropyltriethoxysilane, N-phenyl-3-aminopropyltrimethoxysilane, and 3-mercaptopropyltrimethoxysilane, more preferably at least one member selected from 3-aminopropyltriethoxysilane, 3-methacryloxypropyltrimethoxysilane and 3-glycidoxypropyltrimethoxysilane.

In order to form the primer layer, one type of the first silane compound may be used alone or two or more types may be used in combination. As the first silane compound, for example, a commercial product can be used as the compound (S1).

A component that can optionally be contained in the primer layer may, for example, be a reaction product of a hydrolyzable silane compound other than the first silane compound. When the primer layer contains an optional component, the proportion of the optional component to the entire primer layer is preferably from 0 to 20 mass %, more preferably from 0 to 5 mass %.

### Antifouling Layer

The antifouling layer is formed by using the second silane compound. The antifouling layer is configured to contain a reaction product of the second silane compound as described above, and may contain optional components other than the reaction product of the second silane compound within a range not to impair the effect of the present invention. The proportion of the reaction product of the second silane compound to the entire antifouling layer is preferably from 90 to 100 mass %, more preferably from 95 to 100 mass %.

When the thickness of the antifouling layer is a monomolecular thickness of the second silane compound, the adhesion between the antifouling layer and the primer layer is excellent, and the durability of the antifouling property of the antifouling article is excellent. If the thickness of the antifouling layer is too thick, the utilization efficiency is lowered, and in addition, the transparency of the antifouling layer may be impaired. The thickness of the antifouling layer is specifically preferably from 10 to 100 nm, more preferably from 10 to 50 nm. The thickness of the antifouling layer can be measured in the same manner as in the method of measuring the thickness of the primer layer.

### Second Silane Compound

The second silane compound is a compound having a perfluoropolyether group and a hydrolyzable silyl group. The perfluoropolyether group may be a monovalent group or may be a poly(oxyperfluoroalkylene) chain which is a divalent group.

The second silane compound may specifically be a silane compound (hereinafter referred to as a “silane compound (A)”) which has a poly(oxyperfluoroalkylene) chain represented by —(CₐF₂ₐO)_{b}— (wherein a is an integer of from 1 to 6, b is an integer of at least 2, and it may have at least two —CₐF₂ₐO— units different in the number of carbon atoms), and which has a hydrolyzable silyl group via a linking group at at least one terminal of the poly(oxyperfluoroalkylene) chain.

The silane compound (A) has a hydrolyzable silyl group via a linking group at at least one terminal of —(CₐF₂ₐO)_{b}—. —(CₐF₂ₐO)_{b}— is preferably included in the main chain. The number of hydrolyzable silyl groups bonded to the linking group may be at least 2, preferably from 1 to 3, more preferably from 2 or 3, from the viewpoint of adhesion to the primer layer.

The linking group is a polyvalent group having one bonding hand bonded to the —(CₐF₂ₐO)_{b}— side and at least one bonding hand bonded to a silicon atom of the hydrolyzable silyl group. When the number of hydrolyzable silyl groups bonded to the linking group is 1, the linking group is a divalent group. The bonding hand of the liking group bonded to the —(CₐF₂ₐO)_{b}— side is one made of a carbon atom in a case where the linking group is bonded to the terminal oxygen atom of —(CₐF₂ₐO)_{b}—, and is one made of an oxygen atom in a case where the linking group is bonded to the terminal carbon atom of —(CₐF₂ₐO)_{b}—. The bonding hand of the liking group bonded to a silicon atom of the hydrolyzable silyl group is one made of a carbon atom.

In the silane compound (A), —(CₐF₂ₐO)_{b}— is specifically represented by —(R^{f1}O)ₓ₁(R^{f2}O)ₓ₂(R^{f3}O)ₓ₃(R^{f4}O)ₓ₄(R^{f5}O)ₓ₅(R^{f6}O)ₓ₆—, wherein R^{f1} is a C₁ perfluoroalkylene group, R^{f2} is a C₂ perfluoroalkylene group, R^{f3} is a C₃ perfluoroalkylene group, R^{f4} is a C₄ perfluoroalkylene group, R^{f5} is a C₅ perfluoroalkylene group, R^{f6} is a C₆ perfluoroalkylene group, x1, x2, x3, x4, x5 and x6 are each independently an integer of at least 0, the sum of x1, x2, x3, x4, x5 and x6 is at least 2, and the respective repeating units may be present in block, alternating or random manners.

The poly(oxyperfluoroalkylene) chain represented by —(CₐF₂ₐO)_{b}— in the silane compound (A) preferably contains at least one member selected from the following (a1) to (a3).

(a1) A poly(oxyperfluoroalkylene) chain whose unit is a poly(oxyperfluoroalkylene) group having from 1 to 3 of a group (α) consisting of at least one C₁₋₂ oxyperfluoroalkylene group and from 1 to 3 of a group (β) consisting of at least one C₃₋₆ oxyperfluoroalkylene group, and in which at least two types of the above unit are linked.

A unit which is a poly(oxyperfluoroalkylene) chain having the group (α) and the group (β) is hereinafter referred to as a “unit (αβ)”. The poly(oxyperfluoroalkylene) chain in which at least two units (αβ) are linked is hereinafter referred to as a “chain ((αβ)ₙ)”, wherein n in the chain ((αβ)ₙ) is an integer of at least 2.

(a2) A poly(oxyperfluoroalkylene) chain (hereinafter referred to as a “chain (a2)”) represented by (R^{f1}O)ₓ₁(R^{f2}O)ₓ₂, wherein R^{f1} and R^{f2} are the same as defined above; x1 and x2 are each independently an integer of at least 1, the sum of x1 and x2 is at least 2, and the respective repeating units may be present in block, alternating or random manners.

(a3) A poly(oxyperfluoroalkylene) chain (hereinafter referred to as a “chain (a3)”) represented by (R^{f3}O)ₓ₃, wherein R^{f3} is the same as defined above; x3 is at least 2.

In the silane compound (A), a compound in which —(CₐF₂ₐO)_{b}— contains the chain ((αβ)ₙ) is hereinafter referred to as a silane compound (A1). When the silane compound (A1) is used, an antifouling layer having high initial water- and oil-repellency and excellent fouling-removing property can be particularly formed by the action of the chain ((αβ)ₙ).

In the silane compound (A), a compound in which —(CₐF₂ₐO)_{b}— is composed of the chain (a2) is hereinafter referred to as a silane compound (A2). In the silane compound (A), a compound in which —(CₐF₂ₐO)_{b}— is composed of the chain (a3) is hereinafter referred to as a silane compound (A3).

In this specification, the number average molecular weight of the second silane compound is calculated by the following method using a NMR analysis method.

It is calculated by determining the number (average value) of oxyperfluoroalkylene groups based on the terminal group by ¹H-NMR (solvent: heavy acetone, internal standard: TMS) and ¹⁹F-NMR (solvent: heavy acetone, internal standard: CFCl₃). The terminal group is, for example, A or B in the following formula (1).

The number average molecular weight of the second silane compound is preferably from 2,000 to 10,000. When the number average molecular weight falls within the above range, the abrasion resistance is excellent. The number average molecular weight of the second silane compound is more preferably from 2,100 to 9,000, particularly preferably from 2,400 to 8,000.

Hereinafter, the silane compound (A1), the silane compound (A2), and the silane compound (A3) will be described.

### (1) Silane Compound (A1)

A preferred embodiment of the silane compound (A1) is specifically represented by the following formula (1).

A-O—[(R^{f1}O)ₓ₁(R^{f2}O)ₓ₂(R^{f3}O)ₓ₃(R^{f4}O)ₓ₄(R^{f5}O)ₓ₅(R^{f6}O)ₓ₆]ₙ-B (1)

Here, the symbols in the formula (1) are as follows.

n: an integer of at least 2.

x1 to x2: each independently an integer of from 0 to 3, and x1+x2 is an integer of from 1 to 3.

x3 to x6: each independently an integer of from 0 to 3, and x3+x4+x5+x6 is an integer of from 1 to 3.

R^{f1} to R^{f6}: the same as defined above.

A: a C₁₋₆ perfluoroalkyl group, a C₂₋₆ perfluoroalkyl group having an etheric oxygen atom, or B.

B: a group represented by each of the following formulae (2-1) to (2-5).

—R^{f7}CX₂O(CH₂)₃—SiLₘR₃₋ₘ (2-1)

—R^{f7}CX₂OCH₂CH(CH₃)—SiLₘR₃₋ₘ (2-2)

—R^{f7}C(═O)NHCₖH₂ₖ—SiLₘR₃₋ₘ (2-3)

—R^{f7}(CH₂)₂—SiLₘR₃₋ₘ (2-4)

—R^{f7}(CH₂)₃—SiLₘR₃₋ₘ (2-5)

The symbols in the formulae (2-1) to (2-5) are as follows.

R^{f7}: a C₁₋₂₀ perfluoroalkylene group, which may have an etheric oxygen atom.

X: a hydrogen atom or a fluorine atom.

L: a hydrolyzable group

R: a hydrogen atom or a monovalent hydrocarbon group.

k: an integer of at least 1.

m: an integer of from 1 to 3.

An etheric oxygen atom in this specification is an oxygen atom that forms an ether bond (—O—) between carbon-carbon atoms.

### Unit (αβ)

In the formula (1), the unit (αβ) is a portion represented by [(R^{f1}O)ₓ₁(R^{f2}O)ₓ₂(R^{f3}O)ₓ₃(R^{f4}O)ₓ₄(R^{f5}O)ₓ₅(R^{f6}O)ₓ₆]. The chain ((αβ)ₙ) is a portion represented by [(R^{f1}O)ₓ₁(R^{f2}O)ₓ₂(R^{f3}O)ₓ₃(R^{f4}O)ₓ₄(R^{f5}O)ₓ₅(R^{f6}O)ₓ₆]ₙ). The group (α) is (R^{f1}O) and (R^{f2}O), and the group (β) is (R^{f3}O), (R^{f4}O), (R^{f5}O) and (R^{f6}O). As described above, the order of bonding of the group (α) and the group (β) in the unit (αβ) is not limited, and the chemical formula of the unit (αβ) does not indicate that the group (α) and the group (β) are bonded in this order. In addition, x1 to x6 do not indicate that the respective groups in the unit (αβ) are successively bonded in accordance with their number, but indicate the number of respective groups in the unit (αβ).

n is an integer of at least 2. The upper limit of n is preferably 45, from the viewpoint that when the number average molecular weight of the compound (1) is too large, the number of hydrolyzable silyl groups present per unit molecular weight decreases, and the abrasion resistance decreases. n is more preferably from 4 to 40, particularly preferably from 5 to 35.

In the unit (αβ), the order of bonding of the group (α) and the group (β) is not limited. That is, the group (α) and the group (β) may be randomly arranged, the group (α) and the group (β) may be alternately arranged, and at least two blocks composed of a plurality of the groups may be bonded. It is preferred that the terminal at the side closer to A is the group (α) and the terminal at the side closer to B is the group (β), from the viewpoint that both the characteristic by the group (α) and the characteristic by the group (β) can be exhibited more efficiently.

Specific examples of the unit (αβ) may be as follows.

(CF₂CF₂O—CF₂CF₂CF₂O),

(CF₂C F₂O—CF₂CF₂CF₂CF₂O),

(CF₂CF₂O—CF₂CF₂CF₂CF₂CF₂O),

(CF₂CF₂O—CF₂CF₂CF₂CF₂CF₂CF₂O),

(CF₂CF₂O—CF(CF₃)CF₂O),

(CF₂CF₂OCF₂CF₂O—CF₂CF₂CF₂O),

(CF₂CF₂OCF₂CF₂O—CF₂CF₂CF₂CF₂O),

(CF₂CF₂OCF₂CF₂O—CF₂CF₂CF₂CF₂CF₂O),

(CF₂CF₂OCF₂CF₂O—CF₂CF₂CF₂CF₂CF₂CF₂O),

(CF₂CF₂OCF₂CF₂O—CF(CF₃)CF₂O),

(CF₂CF₂O—CF₂CF₂CF₂O—CF₂CF₂O),

(CF₂CF₂O—CF₂CF₂CF₂OCF₂CF₂CF₂O),

(CF₂CF₂O—CF₂CF₂CF₂OCF₂CF₂CF₂CF₂O),

(CF₂CF₂O—CF₂CF₂CF₂OCF₂CF₂CF₂CF₂CF₂O),

(CF₂CF₂O—CF₂CF₂CF₂OCF(CF₃)CF₂O),

(CF₂CF₂O—CF₂CF₂CF₂CF₂O—CF₂CF₂O),

(CF₂CF₂O—CF₂CF₂CF₂CF₂OCF₂CF₂CF₂O),

(CF₂CF₂O—CF₂CF₂CF₂CF₂OCF₂CF₂CF₂CF₂O),

(CF₂CF₂O—CF₂CF₂CF₂CF₂OCF(CF₃)CF₂O),

(CF₂CF₂O—CF₂CF₂CF₂CF₂CF₂O—CF₂CF₂O),

(CF₂CF₂O—CF₂CF₂CF₂CF₂CF₂OCF₂CF₂CF₂O),

(CF₂CF₂O—CF₂CF₂CF₂CF₂CF₂OCF(CF₃)CF₂O),

(CF₂CF₂O—CF₂CF₂CF₂CF₂CF₂CF₂O—CF₂CF₂O),

(CF₂CF₂O—CF(CF₃)CF₂O—CF₂CF₂O),

(CF₂CF₂O—CF(CF₃)CF₂OCF(CF₃)CF₂O),

(CF₂CF₂O—CF₂CF₂CF₂OCF₂CF₂CF₂CF₂O),

(CF₂CF₂O—CF(CF₃)CF₂OCF₂CF₂CF₂O),

(CF₂CF₂OCF₂CF₂OCF₂CF₂O—CF₂CF₂CF₂O),

(CF₂CF₂OCF₂CF₂OCF₂CF₂O—CF₂CF₂CF₂CF₂O),

(CF₂CF₂OCF₂CF₂OCF₂CF₂O—CF(CF₃)CF₂O),

(CF₂CF₂OCF₂CF₂O—CF₂CF₂CF₂O—CF₂CF₂O),

(CF₂CF₂OCF₂CF₂O—CF(CF₃)CF₂O—CF₂CF₂O),

(CF₂CF₂OCF₂CF₂O—CF₂CF₂CF₂OCF₂CF₂CF₂O),

(CF₂CF₂OCF₂CF₂O—CF₂CF₂CF₂OCF(CF₃)CF₂O),

(CF₂CF₂OCF₂CF₂O—CF(CF₃)CF₂OCF₂CF₂CF₂O),

(CF₂CF₂OCF₂CF₂O—CF(CF₃)CF₂OCF(CF₃)CF₂O),

(CF₂CF₂OCF₂CF₂O—CF₂CF₂CF₂CF₂O—CF₂CF₂O),

(CF₂CF₂O—CF₂CF₂CF₂O—CF₂CF₂OCF₂CF₂O),

(CF₂CF₂O—CF₂CF₂CF₂O—CF₂CF₂O—CF₂CF₂CF₂O),

(CF₂CF₂O—CF₂CF₂CF₂O—CF₂CF₂O—CF(CF₃)CF₂O),

(CF₂CF₂O—CF(CF₃)CF₂O—CF₂CF₂O—CF₂CF₂CF₂O),

(CF₂CF₂O—CF(CF₃)CF₂O—CF₂CF₂O—CF(CF₃)CF₂O),

(CF₂CF₂O—CF₂CF₂CF₂OCF₂CF₂CF₂O—CF₂CF₂O),

(CF₂CF₂O—CF₂CF₂CF₂OCF(CF₃)CF₂O—CF₂CF₂O),

(CF₂CF₂O—CF(CF₃)CF₂OCF₂CF₂CF₂O—CF₂CF₂O),

(CF₂CF₂O—CF(CF₃)CF₂OCF(CF₃)CF₂O—CF₂CF₂O),

(CF₂CF₂O—CF₂CF₂CF₂CF₂O—CF₂CF₂OCF₂CF₂O),

(CF₂OCF₂CF₂O—CF₂CF₂CF₂O),

(CF₂OCF₂CF₂O—CF₂CF₂CF₂CF₂O),

(CF₂OCF₂CF₂O—CF₂CF₂CF₂CF₂CF₂O),

(CF₂OCF₂CF₂O—CF₂CF₂CF₂CF₂CF₂CF₂O),

(CF₂OCF₂CF₂O—CF(CF₃)CF₂O),

(CF₂OCF₂CF₂OCF₂CF₂O—CF₂CF₂CF₂O),

(CF₂OCF₂CF₂OCF₂CF₂O—CF₂CF₂CF₂CF₂O),

(CF₂OCF₂CF₂OCF₂CF₂O—CF₂CF₂CF₂CF₂CF₂O),

(CF₂OCF₂CF₂OCF₂CF₂O—CF₂CF₂CF₂CF₂CF₂CF₂O),

(CF₂OCF₂CF₂OCF₂CF₂O—CF(CF₃)CF₂O),

(CF₂OCF₂CF₂O—CF₂CF₂CF₂O—CF₂CF₂O),

(CF₂OCF₂CF₂O—CF₂CF₂CF₂OCF₂CF₂CF₂O),

(CF₂OCF₂CF₂O—CF₂CF₂CF₂OCF₂CF₂CF₂CF₂O),

(CF₂OCF₂CF₂O—CF₂CF₂CF₂OCF₂CF₂CF₂CF₂CF₂O),

(CF₂OCF₂CF₂O—CF₂CF₂CF₂OCF(CF₃)CF₂O),

(CF₂OCF₂CF₂O—CF₂CF₂CF₂CF₂O—CF₂CF₂O),

(CF₂OCF₂CF₂O—CF₂CF₂CF₂CF₂OCF₂CF₂CF₂O),

(CF₂OCF₂CF₂O—CF₂CF₂CF₂CF₂OCF₂CF₂CF₂CF₂O),

(CF₂OCF₂CF₂O—CF₂CF₂CF₂CF₂OCF(CF₃)CF₂O),

(CF₂OCF₂CF₂O—CF₂CF₂CF₂CF₂CF₂O—CF₂CF₂O),

(CF₂OCF₂CF₂O—CF₂CF₂CF₂CF₂CF₂OCF₂CF₂CF₂O),

(CF₂OCF₂CF₂O—CF₂CF₂CF₂CF₂CF₂OCF(CF₃)CF₂O),

(CF₂OCF₂CF₂O—CF₂CF₂CF₂CF₂CF₂CF₂O—CF₂CF₂O),

(CF₂OCF₂CF₂O—CF(CF₃)CF₂O—CF₂CF₂O),

(CF₂OCF₂CF₂O—CF(CF₃)CF₂OCF(CF₃)CF₂O),

(CF₂OCF₂CF₂O—CF(CF₃)OCF₂CF₂CF₂CF₂O),

(CF₂OCF₂CF₂O—CF(CF₃)CF₂OCF₂CF₂CF₂CF₂CF₂O),

(CF₂OCF₂CF₂OCF₂CF₂OCF₂CF₂O—CF₂CF₂CF₂O),

(CF₂OCF₂CF₂OCF₂CF₂OCF₂CF₂O—CF₂CF₂CF₂CF₂O),

(CF₂OCF₂CF₂OCF₂CF₂OCF₂CF₂O—CF(CF₃)CF₂O),

(CF₂OCF₂CF₂OCF₂CF₂O—CF₂CF₂CF₂O—CF₂CF₂O),

(CF₂OCF₂CF₂OCF₂CF₂O—CF(CF₃)CF₂O—CF₂CF₂O),

(CF₂OCF₂CF₂OCF₂CF₂O—CF₂CF₂CF₂OCF₂CF₂CF₂O),

(CF₂OCF₂CF₂OCF₂CF₂O—CF₂CF₂CF₂OCF(CF₃)CF₂O),

(CF₂OCF₂CF₂OCF₂CF₂O—CF(CF₃)CF₂OCF₂CF₂CF₂O),

(CF₂OCF₂CF₂OCF₂CF₂O—CF(CF₃)CF₂OCF(CF₃)CF₂O),

(CF₂OCF₂CF₂OCF₂CF₂O—CF₂CF₂CF₂CF₂O—CF₂CF₂O),

(CF₂OCF₂CF₂O—CF₂CF₂CF₂O—CF₂CF₂OCF₂CF₂O),

(CF₂OCF₂CF₂O—CF₂CF₂CF₂O—CF₂CF₂O—CF₂CF₂CF₂O),

(CF₂OCF₂CF₂O—CF₂CF₂CF₂O—CF₂CF₂O—CF(CF₃)CF₂O),

(CF₂OCF₂CF₂O—CF(CF₃)CF₂O—CF₂CF₂O—CF₂CF₂CF₂O),

(CF₂OCF₂CF₂O—CF(CF₃)CF₂O—CF₂CF₂O—CF(CF₃)CF₂O),

(CF₂OCF₂CF₂O—CF₂CF₂CF₂OCF₂CF₂CF₂O—CF₂CF₂O),

(CF₂OCF₂CF₂O—CF₂CF₂CF₂OCF(CF₃)CF₂O—CF₂CF₂O),

(CF₂OCF₂CF₂O—CF(CF₃)CF₂OCF₂CF₂CF₂O—CF₂CF₂O),

(CF₂OCF₂CF₂O—CF(CF₃)CF₂OCF(CF₃)CF₂O—CF₂CF₂O),

(CF₂OCF₂CF₂O—CF₂CF₂CF₂CF₂O—CF₂CF₂OCF₂CF₂O), etc.

The unit (αβ) is preferably as follows from the viewpoint of sufficiently imparting initial water- and oil-repellency, and fouling-removing properties to the antifouling layer.

(CF₂CF₂O—CF₂CF₂CF₂O),

(CF₂CF₂O—CF₂CF₂CF₂CF₂O),

(CF₂CF₂O—CF₂CF₂CF₂OCF₂CF₂CF₂O),

(CF₂CF₂O—CF₂CF(CF₃)OCF₂CF₂CF₂O),

(CF₂CF₂O—CF₂CF₂CF₂CF₂OCF(CF₃)CF₂O)

### Group A

A is a C₁₋₆ perfluoroalkyl group, a C₂₋₆ perfluoroalkyl group having an etheric oxygen atom, or B. From the viewpoint of friction resistance, a C₁₋₆ perfluoroalkyl group or a C₂₋₆ perfluoroalkyl group having an etheric oxygen atom is preferred. The perfluoroalkyl group may be linear or branched.

Specific examples of A may be as follows.

The C₁₋₆ perfluoroalkyl group may be:

CF₃—,

CF₃CF₂—,

CF₃(CF₂)₂—,

CF₃(CF₂)₃—,

CF₃(CF₂)₄—,

CF₃(CF₂)₅—,

CF₃CF (CF₃)—, etc.

The C₂₋₆ perfluoroalkyl group having an etheric oxygen atom may be:

CF₃OCF₂CF₂—,

CF₃O(CF₂)₃—,

CF₃O(CF₂)₄—,

CF₃O(CF₂)₅—,

CF₃OCF₂CF₂OCF₂CF₂—,

CF₃CF₂OCF₂CF₂—,

CF₃CF₂O(CF₂)₃—,

CF₃CF₂O(CF₂)₄—,

CF₃CF₂OCF₂CF₂OCF₂CF₂—,

CF₃(CF₂)₂OCF₂CF₂—,

CF₃(CF₂)₂O(CF₂)₃—,

CF₃(CF₂)₂OCF(CF₃)CF₂—,

CF₃CF(CF₃)OCF₂CF₂—,

CF₃CF(CF₃)O(CF₂)₃—,

CF₃CF(CF₃)OCF(CF₃)CF₂—,

CF₃(CF₂)₃OCF₂CF₂—, etc.

A is preferably the following from the viewpoint of sufficiently imparting initial water- and oil-repellency, and fouling-removing properties to the antifouling layer.

CF₃—,

CF₃CF₂—,

CF₃OCF₂CF₂—,

CF₃OCF₂CF₂OCF₂CF₂—,

CF₃CF₂OCF₂CF₂—,

CF₃CF₂O(CF₂)₃—,

CF₃CF₂O(CF₂)₄—,

CF₃CF₂OCF₂CF₂OCF₂CF₂—.

### Group B

The compound (1) has B at one or both terminals of the chain ((αβ)ₙ). When there are two B in the molecule, they may be the same or different. As described above, according to the expression of the chemical formula, when B is described on the left side of the chemical formula, B is bonded to the terminal carbon atom of the chain ((αβ)ₙ) via an oxygen atom, that is, B—O— is bonded to the left side of the chain ((αβ)ₙ).

B is a group represented by each of the formulae (2-1) to (2-5), and the compound (1) has a hydrolyzable silyl group represented by —SiLₘRₘ₋₃ at its terminal. The group represented by the formula (2-3) is particularly preferred from the viewpoint of ease of handling in industrial production.

Hereinafter, the compound (1) in which B is a group represented by the formula (2-1) is referred to as the compound (1-1). The compound (1) in which B is a group represented by the formula (2-2) is referred to as the compound (1-2). The compound (1) in which B is a group represented by the formula (2-3) is referred to as the compound (1-3). The compound (1) in which B is a group represented by the formula (2-4) is referred to as the compound (1-4). The compound (1) in which B is a group represented by the formula (2-5) is referred to as the compound (1-5).

A-O—[(R^{f1}O)ₓ₁(R^{f2}O)ₓ₂(R^{f3}O)ₓ₃(R^{f4}O)ₓ₄(R^{f5}O)ₓ₅(R^{f6}O)ₓ₆]ₙ—R^{f7}CX₂O(CH₂)₃—SiLₘR₃₋ₘ (1-1),

A-O—[(R^{f1}O)ₓ₁(R^{f2}O)ₓ₂(R^{f3}O)ₓ₃(R^{f4}O)ₓ₄(R^{f5}O)ₓ₅(R^{f6}O)ₓ₆]ₙ—R^{f7}CX₂OCH₂CH(CH₃)—SiLₘR_{3- m} (1-2),

A-O—[(R^{f1}O)ₓ₁(R^{f2}O)ₓ₂(R^{f3}O)ₓ₃(R^{f4}O)ₓ₄(R^{f5}O)ₓ₅(R^{f6}O)ₓ₆]ₙ—R^{f7}C(═O)NHCₖH₂ₖ—SiLₘR₃₋ₘ (1-3),

A-O—[(R^{f1}O)ₓ₁(R^{f2}O)ₓ₂(R^{f3}O)ₓ₃(R^{f4}O)ₓ₄(R^{f5}O)ₓ₅(R^{f6}O)ₓ₆]ₙ—R^{f7}(CH₂)₂—SiLₘR₃₋ₘ (1-4),

A-O—[(R^{f1}O)ₓ₁(R^{f2}O)ₓ₂(R^{f3}O)ₓ₃(R^{f4}O)ₓ₄(R^{f5}O)ₓ₅(R^{f6}O)ₓ₆]ₙ—R^{f7}(CH₂)₃—SiLₘR₃₋ₘ (1-5)

R^{f7} is a C₁₋₂₀ perfluoroalkylene group, which may have an etheric oxygen atom. The perfluoroalkylene group may be linear or branched. From the viewpoint of sufficiently imparting initial water- and oil-repellency, friction resistance, and fingerprint fouling-removing properties to the antifouling layer, the following is preferred.

—CF₂CF₂OCF₂CF₂—,

—CF₂CF₂OCF₂CF₂CF₂—,

—CF₂CF₂OCF₂CF₂CF₂OCF₂CF₂—,

—CF₂CF₂OCF₂CF(CF₃)OCF₂CF₂—,

—CF₂CF₂OCF₂CF₂CF₂CF₂OCF(CF₃)—

L is a hydrolyzable group. L may be an alkoxy group, a halogen atom, an acyl group, or an isocyanate group (—NCO). As the alkoxy group, a C₁₋₄ alkoxy group is preferred.

L may be preferably a C₁₋₄ alkoxy group or a halogen atom from the viewpoint of easy industrial production. As the halogen atom, a chlorine atom is particularly preferred. As L, a C₁₋₄ alkoxy group is preferred from the viewpoint that outgassing at the time of applying is small and storage stability of the compound (1) is excellent. An ethoxy group is particularly preferred when long-term storage stability of the compound (1) is necessary, and a methoxy group is particularly preferred when the reaction time after applying is made to be short.

R is a hydrogen atom or a monovalent hydrocarbon group. The monovalent hydrocarbon group may be an alkyl group, a cycloalkyl group, an alkenyl group, and an allyl group. As R, a monovalent hydrocarbon group is preferred, and a monovalent saturated hydrocarbon group is particularly preferred. The number of carbon atoms of the monovalent saturated hydrocarbon group is preferably from 1 to 6, more preferably from 1 to 3, particularly preferably from 1 to 2. As R, a C₁₋₆ alkyl group is preferred, a C₁₋₃ alkyl group is more preferred, and a C₁₋₂ alkyl group is particularly preferred from the viewpoint of simple synthesis.

k is an integer of at least 1, and an integer of from 2 to 6 is preferred, and 3 is particularly preferred. When k is at least 3, CₖH₂ₖ may be linear or branched, but a linear chain is preferred.

m is an integer of from 1 to 3, preferably 2 or 3, particularly preferably 3. The presence of a plurality of L in the molecule makes the bond with the surface of the substrate stronger. When m is at least 2, a plurality of L present in one molecule may be the same or different from one another. From the viewpoints of availability of raw material and ease of manufacture, it is preferred that they are the same as one another.

The hydrolyzable silyl group (—SiLₘR₃₋ₘ) is preferably —Si(OCH₃)₃, —SiCH₃(OCH₃)₂, —Si(OCH₂CH₃)₃, —SiCl₃, —Si(OCOCH₃)₃, or —Si(NCO)₃. From the viewpoint of ease of handling in industrial manufacturing, —Si(OCH₃)₃ is particularly preferred.

### Preferred Embodiment

The compound (1) is preferably a compound in which the above-mentioned preferred A and the above-mentioned preferred unit (αβ) are combined, and particularly preferably a compound represented by each of the following formula (1-1Ha), the following formula (1-1Fa), the following formula (1-3a), the following formula (1-4a), and the following formula (1-5a). In the formula number, H indicates that X in the formula (1-1) is a hydrogen atom, and F indicates that X in the formula (1-1) is a fluorine atom. The compounds (1-1Ha), compound (1-1Fa), compound (1-3a), compound (1-4a), and compound (1-5a) are easy to industrially produce and to handle, and are capable of sufficiently imparting initial water- and oil-repellency and fouling-removing properties to the antifouling layer.

A-O—(CF₂CF₂O—CF₂CF₂CF₂CF₂O)ₙ—CF₂CF₂OCF₂CF₂CF₂CH₂O(CH₂)₃—SiLₘR₃₋ₘ (1-1Ha),

A-O—(CF₂CF₂O—CF₂CF₂CF₂CF₂O)ₙ—CF₂CF₂OCF₂CF₂CF₂CF₂O(CH₂)₃—SiLₘR₃₋ₘ (1-1Fa),

A-O—(CF₂CF₂O—CF₂CF₂CF₂CF₂O)ₙ—CF₂CF₂OCF₂CF₂CF₂C(═O)NH(CH₂)₃—SiLₘR₃₋ₘ (1-3a),

A-O—(CF₂CF₂O—CF₂CF₂CF₂CF₂O)ₙ—CF₂CF₂OCF₂CF₂CF₂(CH₂)₂—SiLₘR₃₋ₘ (1-4a),

A-O—(CF₂CF₂O—CF₂CF₂CF₂CF₂O)ₙ—CF₂CF₂OCF₂CF₂CF₂(CH₂)₃—SiLₘR₃₋ₘ (1-5a)

A is CF₃—, CF₃CF₂—, CF₃CF₂OCF₂CF₂CF₂CF₂—, CF₃OCF₂CF₂—, CF₃OCF₂CF₂OCF₂CF₂— or CF₃CF₂OCF₂CF₂OCF₂CF₂—.

n is an integer of at least 2, and the preferred range is the same as that of the compound (1).

SiLₘR₃₋ₘ is the same as SiLₘR₃₋ₘ in the compounds (1-1) to (1-5), including the preferred embodiment.

The silane compound (A1) can be prepared, for example, by the method described in WO2013/121984.

### (2) Silane Compound (A2)

A preferred embodiment of the silane compound (A2) is specifically represented by the following formula (3).

[A-O—(R^{f1}O)ₓ₁(R^{f2}O)ₓ₂]Q[B¹]_{b1} (3)

Here, the symbols in the formula (3) are as follows.

Q: a (1+b1) valent linking group

R^{f1}, R^{f2}, x1, x2: the same as those of the above chain (a2).

A: a C₁₋₆ perfluoroalkyl group or a C₂₋₆ perfluoroalkyl group having an etheric oxygen atom.

b1: an integer of from 1 to 3

B¹: a group represented by —SiLₘR₃₋ₘ (L, R and m are the same as those of the formula (1)).

x1 is preferably from 1 to 200, more preferably from 5 to 100.

x2 is preferably from 1 to 200, more preferably from 5 to 100.

x1+x2 is preferably from 2 to 200, more preferably 10 to 100.

When b1 is 1 in the compound (3), Q may be the following divalent linking group or a single bond.

—R^{f7}CX₂O(CH₂)₃—

—R^{f7}CX₂OCH₂CH(CH₃)—

—R^{f7}C(═O)NHCₖH₂ₖ—

—R^{f7}(CH₂)₂—

—R^{f7}(CH₂)₃—

R^{f7}, X, and k are the same as in the above formulae (2-1) to (2-5).

When b1 is at least 2 in the compound (3), Q[B¹]_{b1} may be the following structure:

-Q¹-C(OH)(Q²-B¹)₂

-Q¹-C(Q²-B¹)₃

-Q¹-Si(Q²-B¹)₃

—Q¹-Y(Q²-B¹)₃(CH₃)₄

Q¹ is the same as Q when b1 is 1, and B¹ is the same as described above.

Q² is independently —O—(CH₂)₃—, —(CH₂)₃—, —(CH₂)₄—, —CH₂O(CH₂)₃—, —CH₂O(CH₂)₅—, —(CH₂)₃—Si(CH₃)₂—Ph—Si(CH₃)₂—(CH₂)₂—(CH₂)₂—, or —(CH₂)₃—Si(CH₃)₂—O—Si(CH₃)₂—(CH₂)₂—.

Y is a cyclic siloxane having 4 silicon atoms.

The compound (3) may be the following compound. In each of the following formulae, m corresponds to x1 in the formula (3), and n corresponds to x2.

PFPE is A-O—(R^{f1}O)ₓ₁(R^{f2}O)ₓ₂-Q¹—.

(3-1) Compound in which b1 is 1 in compound (3)

CF₃O(CF₂O)m(CF₂CF₂O)nCF₂CH₂OCH₂CH₂CH₂Si(OCH₃)₃

(3-2) Compound in which Q[B¹]_{b1} is -Q¹-C(OH)(Q²-B¹)₂ in compound (3)

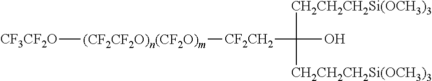

(3-3) Compound in which Q[B¹]_{b1} is -Q¹-C(Q²-B¹)₃ in compound (3)

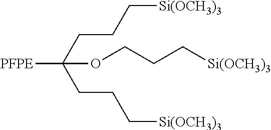

In the formula, PFPE represents CF₃CF₂O(CF₂CF₂O)ₙ(CF₂O)ₘCF₂CH₂—.

(3-4) Compound in which Q[B¹]_{b1} is -Q¹-Si(Q²-B¹)₃ in compound (3)

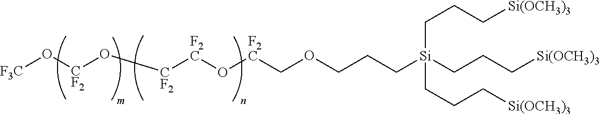

(3-5) Compound in which Q[B¹]_{b1} is -Q¹-Y(Q²-B¹)₃(CH₃)₄ in compound (3)

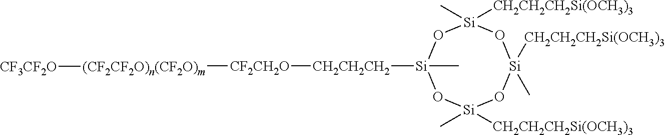

(3) Silane compound (A3)

A preferred embodiment of the silane compound (A3) is specifically represented by the following formula (4) or formula (5).

[A-O—(R^{f3}O)ₓ₃]Q[B¹]_{b1} (4)

A-O—(R^{f3}O)ₓ₃-Q³-(CH₂—CHB¹)_{b3}—H (5)

Here, the symbols in the formulae (4) and (5) are as follows.

Q is a (1+b1) valent linking group and is the same as Q in formula (3).

Q³: a divalent linking group

R^{f3}, x3: the same as those of the above chain (a3).

A: a C₁₋₆ perfluoroalkyl group or a C₂₋₆ perfluoroalkyl group having an etheric oxygen atom.

b1: an integer of from 1 to 3

b3: an integer from 1 to 10

B¹: a group represented by —SiLₘR₃₋ₘ (L, R, m are the same as those in the formula (1)).

When b1 is at least 2 in the compound (4), Q[B¹]_{b1} can be the same structure as those of the compound (3). In the compound (5), Q³ can be the same divalent group as R^{f7}. In the compounds (4) and (5), x3 is preferably from 2 to 200, more preferably from 10 to 100.

The compound (4) may, for example, be the following compound. In each of the following formulae, n corresponds to x3 in the formula (4). PFPE is A-O—(R^{f3}O)ₓ₃—.

(4-1) Compound in which b1 is 1 in compound (4)

CF₃CF₂CF₂O(CF₂CF₂CF₂O)ₙCF₂CF₂CH₂OCH₂CH₂CH₂Si(OCH₃)₃

(4-2) Compound in which Q[B¹]_{b1} is -Q¹-Si(Q²-B¹)₃ in compound (4)

CF₃CF₂CF₂O(CF₂CF₂CF₂O)₂₀CF₂CF₂CH₂OCH₂CH₂CH₂Si[CH₂CH₂CH₂Si(OCH₃)₃]₃

The compound (5) may, for example, be the following compound. In the following formula, n corresponds to x3 in the formula (5), m corresponds to b3 in the formula (5), and Me is a methyl group.

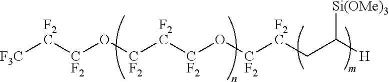

In order to form the antifouling layer, one type of the second silane compound may be used alone or at least two types may be used in combination. A component which the antifouling layer can optionally contain may, for example, be a hydrolyzable silane compound other than the second silane compound, fine particles of an oxide of a metal such as silica, alumina, zirconia, or titania, a dye, a pigment, an antifouling material, a curing catalyst, or a various resin. When the antifouling layer contains an optional component, the proportion of the optional component to the entire antifouling layer is preferably at most 10 mass %, more preferably at most 5 mass %. The proportion of the optional component to the total antifouling layer may be, for example, from 1 to 5 mass %.

The antifouling layer may contain an impurity as an optional component. The impurity means a compound unavoidable for the production of the second silane compound. Specifically, it is a by-product generated in the production process of the second silane compound and a component mixed in the production process. When the antifouling layer contains an impurity, the proportion of the impurity to the entire antifouling layer is preferably at most 5 mass %, more preferably at most 2 mass %.

### Antifouling Article

The antifouling article of the present invention comprises a substrate, at least a portion of the surface thereof being made of an organic material; and a primer layer and an antifouling layer disposed, in this order, on the surface made of the organic material. The antifouling article of the present invention may contain another member other than these, if necessary. The primer layer is formed on at least a portion of the surface of the substrate made of the organic material. The region where the primer layer is formed may cover the region where the antifouling layer is formed, and may be formed in a region larger than the region where the antifouling layer is formed, as necessary.

The antifouling article of the present invention is produced by forming the primer layer on the surface of the substrate made of an organic material using the first silane compound, and then forming the antifouling layer on the primer layer using the second silane compound. The antifouling article of the present invention can be specifically produced by the following method.

### Method for Producing Antifouling Article

The method for producing an antifouling article of the present invention comprises the following steps (I) and (II).

(I) A step of applying, onto the surface made of the organic material, a composition for primer layer comprising the first silane compound and the first solvent; and then reacting the first silane compound to obtain the primer layer (hereinafter also referred to as a “primer layer-forming step”).

(II) A step of depositing, on the primer layer, the composition for antifouling layer comprising the second silane compound; and then reacting the second silane compound to obtain the antifouling layer (hereinafter also referred to as a “antifouling layer-forming step”).

Here, the first silane compound is the above-described first silane compound that has the reactive organic group (A) and a hydrolyzable silyl group, wherein the absolute value of the difference between the SP value of the organic material constituting the surface on which the primer layer is to be formed and the SP value of the reactive organic group (A) is from 0 to 3.0 (J/cm³)^{1/2}. The second silane compound is the above-described second silane compound having a perfluoropolyether group and a hydrolyzable silyl group.

According to the production method of the present invention, when the SP value (SP_{fg}) of the reactive organic group (A) of the first silane compound in the primer layer and the SP value (SPₒₘ) of the organic material in the substrate satisfy the above relation (i.e. the above formula (i)), the primer layer can be uniformly formed on the surface of the organic material with excellent adhesion.

The production method of the present invention may contain an additional step in addition to the steps (I) and (II). As the additional step, it is preferred to contain, before the step (I), a step (hereinafter referred to as a “step (Ib)”) of activating the surface of the organic material of the substrate on which the primer layer is to be formed. Further, the production method of the present invention may contain, after the antifouling layer- forming step (II), a step (hereinafter referred to as a “step (IIa)”) of performing post-treatment on the antifouling layer. Hereinafter, the respective steps will be described.

### (Ib) Activation Treatment of Organic Material Surface

The step (Ib) is a step of activating the surface of the organic material. Activating the surface of the organic material means modifying the surface of the organic material so that a reactive group is present. This makes it easier for the first silane compound to be bonded to the surface of the organic material.

In the present invention, as the activation treatment of the surface of the organic material, dry treatment or wet treatment used for activating the surface of the organic material may be applicable without any particular limitation. As the dry treatment, treatment of irradiating a surface with active energy rays such as ultraviolet rays, electron beams, or X-rays, corona treatment, vacuum plasma treatment, atmospheric pressure plasma treatment, flame treatment, itro treatment, or the like can be used. As the wet treatment, treatment of contacting the surface with an acid or alkaline solution can be exemplified. In the present invention, the activation treatment preferably used is plasma treatment, and a combination of plasma treatment and wet acid treatment is more preferred.

The plasma treatment is not particularly limited, but may be RF plasma treatment in vacuum, microwave plasma treatment, microwave ECR plasma treatment, atmospheric pressure plasma treatment, corona treatment, or the like. The plasma treatment may encompass gas treatment including fluorine, ion implantation treatment using an ion source, treatment using a PBII method, flame treatment exposed to thermal plasma, intro treatment, or the like. Among these, RF plasma treatment in vacuum, microwave plasma treatment, or atmospheric pressure plasma treatment is preferred.

As a suitable condition of the plasma treatment, it is desirable to perform treatment using a plasma known to have a high chemically etching effect, such as an oxygen plasma or a plasma containing fluorine such as CF₄ or C₂F₆, or a plasma having a high physically etching effect by applying a physical energy to the surface of an organic material, such as a plasma of Ne, Ar, Kr, Xe, or the like. It is also preferred to add a plasma such as CO₂, CO, H₂, N₂, NH₄, or CH₄, a mixed gas thereof, or further water vapor. In addition to these, it is also preferred to add a plasma containing at least one component selected from the group consisting of OH, N₂, N, CO, CO₂, H, H₂, O₂, NH, NH₂, NH₃, COOH, NO, NO₂, He, Ne, Ar, Kr, Xe, CH₂O, Si(OCH₃)₄, Si(OC₂H₅)₄, C₃H₇Si(OCH₃)₃, and C₃H₇Si(OC₂H₅)₃ as a gas or as a decomposition product in the plasma.

When treatment in a short time is aimed, it is desirable to use a plasma having a high energy density, a high kinetic energy of ions in the plasma, and a high number density of active species, but there is a limitation in increasing the energy density because the surface smoothness is required. If an oxygen plasma is used, the surface oxidation proceeds, the surface having poor adhesion to the substrate itself is easily formed, and the surface roughness is increased, thereby the adhesion is also lowered.

In addition, in a plasma using an Ar gas, the influence of pure physical collision occurs at the surface, and in this case the surface roughness is increased. Taking these into consideration comprehensively, microwave plasma treatment, microwave ECR plasma treatment, plasma irradiation by an ion source that can easily shoot high-energy ions, or a PBII method is also preferred.

The activation treatment cleans the surface of the organic material and further generates the reactive group. The generated reactive group is linked to the first silane compound by a hydrogen bonding or a chemical reaction, and the organic material on the surface of the substrate and the primer layer can be strongly bonded to each other.

In the plasma treatment, an effect of etching the surface of the organic material can also be obtained. Especially in an organic material containing a relatively large number of lubricant particles, the protrusion due to the lubricant particles may hinder the adhesiveness. In this case, when the surface of the organic material is thinly etched by plasma treatment to expose a part of the lubricant particles and then treated with a hydrofluoric acid, the lubricant particles in the vicinity of the surface of the organic material can be removed.

The activation treatment may be performed at least on the surface of the organic material on which the primer layer is to be formed. For example, in a case where the primer layer is formed on one main surface of a plate-shaped substrate in which the entire substrate is made of an organic material, and where plasma treatment is performed only on the main surface, the following plasma treatment may be performed.

That is, in plasma treatment by using a parallel plate type electrode, plasma treatment may be performed only on one main surface of the substrate which is not in contact with an electrode, by placing the substrate on the electrode so that one main surface opposed to one main surface to be subjected to plasma treatment, can be in contact with the electrode. In plasma treatment by using a parallel plate type electrode, plasma treatment may be performed on both main surfaces of the substrate by placing the substrate in a state of being electrically floated in the space between the two electrodes. In addition, plasma treatment may be performed on one surface by performing plasma treatment in a state where a protective film is attached to one surface of the substrate. As the protective film, a PET film with an adhesive, a polyolefin film, or the like can be used.

### (I) Primer Layer-Forming Step

The primer layer-forming step is a step of applying the composition for primer layer containing the first silane compound and the first solvent to the surface of the organic material of the substrate, preferably the surface of the organic material after the above step (Ib), and then reacting the first silane compound.

The composition for primer layer comprises the first silane compound and the first solvent. The first silane compound is as described above. When the first silane compound is blended in the composition for primer layer, the first silane compound may be blended as it is, or may be blended as its oligomer (partially hydrolyzed condensate). Alternatively, the first silane compound and its oligomer may be blended in the composition for primer layer as a mixture of the first silane compound and the oligomer.

When at least two types of the first silane compound are used in combination, each compound may be blended in the composition for primer layer as it is, each may be blended as a oligomer thereof, or may be blended as a co-oligomer (partially hydrolyzed co-condensate) of at least two types of the compound.

It may also be a mixture of such a compound, oligomer (partially hydrolyzed condensate), and co-oligomer (partially hydrolyzed co-condensate). The oligomer and co-oligomer also have hydrolyzable groups (including hydrolyzed silanol groups) and the reactive organic groups (A) as described above. Hereinafter, the term “the composition for primer layer contains the first silane compound” encompasses that the composition for primer layer contains such an oligomer or co-oligomer as well as the first silane compound itself.

The oligomer and the co-oligomer of the first silane compound are meant for a multimer formed by hydrolyzing a part or all of hydrolyzable silyl groups of the first silane compound in the presence of a catalyst such as an acid catalyst or an alkali catalyst in a solvent, followed by dehydration condensation. The degree of condensation (degree of multimerization) of the multimer is the extent to which the product dissolves in the solvent.

The composition for primer layer contains the first solvent. The solvent used in the preparation of the oligomer and the co-oligomer (hereinafter, also referred to as a “third solvent”) may be the same as or different from the first solvent. The third solvent may be used as the first solvent of the composition for primer layer as long as it falls within the preferred range of the first solvent as described below. The third solvent may be removed as necessary.

The content proportion of the first silane compound in the composition for primer layer is preferably from 0.01 to 5 mass %, more preferably from 0.05 to 3 mass %, particularly preferably from 0.1 to 2 mass % to the total amount of the composition from the viewpoint that the primer layer is easily formed uniformly.

The first solvent is not particularly limited as long as it can dissolve the first silane compound. The first solvent may be preferably a solvent having high compatibility with the hydrolyzed product of the first silane compound in which the hydrolyzable silyl group of the first silane compound is hydrolyzed to the silanol group. The first solvent preferably has a high affinity with the surface of the organic material on which the primer layer is to be formed. Specifically, the first solvent satisfies preferably either of the following formula (ii) or (iii), more preferably both of them.

|SPₛᵥ−SP_{OH}|≤12.0 (J/cm³)^{1/2} (ii)

|SPₛᵥ−SPₒₘ|≤5.0 (J/cm³)^{1/2} (iii)

In the formulae (ii) and (iii), SPₛᵥ represents the SP value of the first solvent, SP_{OH} represents the SP value in the case where the hydrolyzable silyl group of the first silane compound is converted to the silanol group, and SPₒₘ is the same as in the formula (i) above.

When the first solvent satisfies the formula (ii), that is, |SPₛᵥ−SP_{OH}| is in a range of from 0 to 12.0 (J/cm³)^{1/2}, the compatibility between the first solvent and the hydrolyzed product of the first silane compound is sufficiently high, and excessive condensation of the hydrolyzed product of the first silane compound is suppressed, so that the primer layer can be uniformly formed on the surface of the organic material without unevenness.

As described above, the primer layer is bonded at an interface with the antifouling layer formed on the primer layer by a siloxane bonding. Therefore, in the primer layer formed according to the primer layer-forming step, it is preferred that a considerable amount of silanol groups in the hydrolyzed product of the first silane compound is stably present while a part of silanol groups reacts intermolecularly. In this respect, it can be said that the primer layer obtained according to the primer layer-forming step is completed by combining with the antifouling layer in the next antifouling layer-forming step (II).

The condition of the above formula (ii) is set from such a viewpoint, and |SPₛᵥ−SP_{OH}| is in a range of preferably from 3.0 to 12.0 (J/cm³)^{1/2}, more preferably from 5.0 to 12.0 (J/cm³)^{1/2}, particularly preferably from 7.0 to 12.0 (J/cm³)^{1/2}. |SPₛᵥ−SP_{OH}| is preferably close to 0 from the viewpoint of compatibility, but the lower limit is preferably within the above ranges from the viewpoint of good balancing with |SP_{fg}−SPₒₘ| and |SPₛᵥ−SPₒₘ|.

When the first solvent satisfies the formula (iii), that is, |SPₛᵥ−SPₒₘ| is in a range of from 0 to 5.0 (J/cm³)^{1/2}, the affinity between the first solvent and the surface of the organic material is sufficiently high, and as the first solvent wets the surface of the organic material, an effect of promoting the reaction between the reactive organic group (A) of the first silane compound and the surface of the organic material is obtained. |SPₛᵥ−SPₒₘ| is in a range of preferably from 0 to 4.5 (J/cm³)^{1/2}, more preferably from 1.0 to 4.5 (J/cm³)^{1/2}, particularly preferably from 1.5 to 4.5 (J/cm³)^{1/2}, most preferably from 1.5 to 3.8 (J/cm³)^{1/2}. |SPₛᵥ−SPₒₘ| is preferably close to 0 from the viewpoint of compatibility, but the lower limit is preferably within the above ranges from the viewpoint of good balancing with |SP_{fg}−SPₒₘ| and |SPₛᵥ−SP_{OH}|.

The SP value (SPₛᵥ) of the first solvent is in a range of preferably from 14.0 to 45.0 (J/cm³)^{1/2}, more preferably from 20.0 to 35.0 (J/cm³)^{1/2}. In the above range, the affinity with the surface of the organic material is excellent.

The first solvent may specifically be water, an organic solvent, or the like. The first solvent may consist of a single compound or a mixed solvent of at least two compounds. In the case of the mixed solvent, SPₛᵥ is a weighted average based on the composition mass of each compound. As the first solvent, a non-fluorinated organic solvent or a mixed solvent of a non-fluorinated organic solvent and water is preferred from the viewpoint of SPₛᵥ.

The non-fluorinated organic solvent may be preferably a compound composed only of hydrogen atoms and/or chlorine atoms and carbon atoms, or a compound composed only of hydrogen atoms, carbon atoms and oxygen atoms, and may be a hydrocarbon-type organic solvent, an alcohol-type organic solvent, a ketone-type organic solvent, an ether-type organic solvent, an ester-type organic solvent, or a chlorine-type solvent. The specific compounds and their SPₛᵥ are shown below. In the following examples, SPₛᵥ is described within parentheses after the compound, omitting the unit (J/cm³)^{1/2}. In addition, SPₛᵥ of water is 47.8 (J/cm³)^{1/2}.

The hydrocarbon-type organic solvent may be preferably hexane (14.8), heptane (15.3), cyclohexane (16.7), toluene (18.2), or the like.

The alcohol-type organic solvent may be preferably methanol (29.2), ethanol (26.4), propanol (24.5), isopropanol (IPA, 23.5), or the like.

The ketone-type organic solvent may be preferably acetone (20.0), methyl ethyl ketone (19.0), methyl isobutyl ketone (17.0), or the like.

The ether-type organic solvent may be preferably diethyl ether (14.8), tetrahydrofuran (19.5), tetraethylene glycol dimethyl ether (17.5), or the like.

The ester-type organic solvent may be preferably ethyl acetate (18.6), butyl acetate (17.8), or the like.

The chlorine-type solvent may be preferably 1,1-dichloroethane (19.7), 1,2-dichloroethane (19.7), 1,1,2-trichloroethane (21.8), 1,1,1,2-tetrachloroethane (23.7), 1,1,2,2-tetrachloroethane (23.7), pentachloroethane (23.1), 1,1-dichloroethylene (23.5), (Z)-1,2-dichloroethylene (23.5), (E)-1,2-dichloroethylene (23.5), trichlorethylene (18.8), tetrachlorethylene (19.0), chloroform (19.2), carbon tetrachloride (17.2), dichloromethane (19.9), or the like.

Here, although water for hydrolyzing the hydrolyzable silyl group of the first silane compound can be provided by moisture in the air, it is preferred that the first solvent contains water and the water is used for hydrolysis.

The content proportion of water in the composition for primer layer is preferably from 0.5 to 2.0 mol, more preferably from 0.8 to 1.3 mol, per 1 mol of a hydrolyzable group bonded to a silicon atom of the first silane compound. The content proportion of water in the first solvent is preferably from 1 to 30 mass %, more preferably from 5 to 10 mass %, to the total amount of the first solvent in view of SPₛᵥ as stated above.

The SP value (SP_{OH}) in a case where the hydrolyzable silyl group of the first silane compound is converted to the silanol group, which should be referred to in determining whether the formula (ii) is satisfied when the first solvent is selected, is shown in Table 3, listing typical examples of the first silane compound. The SP value of the first silane compound itself is also shown as SPₛₗ in Table 3.

TABLE 3

SP value
(J/cm³)^{1/2}

| First silane compound | SPₛₗ | SP_{OH} |
|---|---|---|
| Vinyldimethylmonoethoxysilane | 14.5 | 20.7 |
| Vinylmethyldiethoxysilane | 15.3 | 28.3 |
| Vinyltriethoxysilane | 16.0 | 37.5 |
| 3-Aminopropylmethyldiethoxysilane | 17.2 | 28.0 |
| 3-Aminopropyltriethoxysilane | 17.6 | 35.1 |
| 3-Methacryloxypropylmethyldimethoxysilane | 18.0 | 26.0 |
| 3-Glycidoxypropyltrimethoxysilane | 17.4 | 34.2 |
| 3-Methacryloxypropyltrimethoxysilane | 18.2 | 30.8 |

As shown in Table 3, SP_{OH} depends mainly on the number of hydrolyzable groups in the first silane compound. When the hydrolyzable group is a methoxy group or an ethoxy group and the number of hydrolyzable groups is one, SP_{OH} tends to be in a range of approximately from 20.0 to 25.0 (J/cm³)^{1/2}. Similarly, when the hydrolyzable group is a methoxy group or an ethoxy group and the number of hydrolyzable groups is two, the SP_{OH} tends to be in range of approximately from 25.0 to 30.0 (J/cm³)^{1/2}, and when the number of hydrolyzable groups is three, SP_{OH} tends to be in range of approximately from 30.0 to 40.0 (J/cm³)^{1/2}.

The SP value (SPₒₘ) of the organic material constituting the surface of the organic material of the substrate, which should be referred to in determining whether the formula (iii) is satisfied when the first solvent is selected, is as shown in Table 1, for example.

In the production method of the present invention, the first silane compound is selected so as to satisfy the formula (i) depending on the organic material on the surface of the substrate on which the primer layer is to be formed. The first solvent used in the composition for primer layer is selected to satisfy preferably the formula (ii) or the formula (iii), more preferably the formula (ii) and the formula (iii), in accordance with the organic material and the first silane compound.

For example, when the organic material of the substrate is PE, SPₒₘ is 16.4. Then, the reactive organic group (A) having a vinyl group, an epoxy group, a (meta)acylloxy group, a mercapto group, an amino group, or the like (where SP_{fg} satisfies the formula (i), that is, SP_{fg} is from 13.4 to 19.4), is selected as the first silane compound. The first solvent preferably has SPₛᵥ of from 11.4 to 21.4 so that the first solvent satisfies the formula (iii) in relation to SPₒₘ.

The number of hydrolyzable groups bonded to silicon atoms of the first silane compound is preferably adjusted so that SPₛᵥ of the first solvent in the above range satisfies the formula (ii) in relation to SP_{OH}. Specifically, when the hydrolyzable group bonded to a silicon atom of the first silane compound is a methoxy group or an ethoxy group and SPₛᵥ is, for example, 16.4, the first silane compound in which the number of hydrolyzable groups bonded to silicon atoms is 1 or 2 can be selected so that SPₛᵥ be in a range from 4.4 to 28.4, thereby satisfying the formula (ii).

The content proportion of the first solvent in the composition for primer layer is preferably from 95 to 99.99 mass %, more preferably from 97 to 99.95 mass %, particularly preferably from 98 to 99.9 mass %.

The composition for primer layer may contain an optional ingredient in an amount of at least 20 mass %, preferably at least 5 mass %, to the total solid content, as described above. As another component, a known additive such as an acid catalyst or a basic catalyst for promoting hydrolysis and condensation reactions of the hydrolyzable silyl group, for example, may be contained. The acid catalyst may be a sulfonic acid such as hydrochloric acid, nitric acid, acetic acid, sulfuric acid, phosphoric acid, methanesulfonic acid, or p-toluenesulfonic acid, or the like. The basic catalyst may be sodium hydroxide, potassium hydroxide, ammonia, or the like. The content of the another component in the composition for primer layer is in a range of preferably at most 10 mass %, particularly preferably at most 1 mass %, to the total amount of the composition for primer layer.

The composition for primer layer is required to be uniformly and smoothly applied to the surface of the organic material of the substrate so that the primer layer can be formed uniformly. The composition for primer layer forms the primer layer by reacting the first silane compound after the application as described above. That is, the reactive organic group (A) and the surface of the organic material are reacted to form a chemical bond. The first silane compound is hydrolyzed to generate silanol groups, and some of the silanol groups are condensed to be bonded intermolecularly. The remainder of the silanol groups are subjected to a condensation reaction with silanol groups generated from the second silane compound in the antifouling layer-forming step (II).

Therefore, the composition for primer layer preferably has a pH which stabilizes silanol groups generated by the hydrolysis reaction and which promotes the hydrolysis reaction of the first silane compound. From this viewpoint, the pH of the composition for primer layer is preferably from 2 to 5, and more preferably from 2 to 3.

The composition for primer layer can be produced by mixing the above respective components. A known method can be appropriately used for applying the composition for primer layer to the surface of the organic material of the substrate.

The applying method may be preferably a spin coating method, a wipe coating method, a spray coating method, a squeegee coating method, a dip coating method, a die coating method, an inkjet method, a flow coating method, a roll coating method, a casting method, a Langmuir-Blodgett method, or a gravure coating method. In addition, it is also possible to apply the composition by a simple method such as hand application or brush application.

The composition for primer layer is preferably applied so that the applied amount of the first silane compound be from 1.0 to 4.0 mg/m², in order to make the preferred thickness of the obtained primer layer as described above. The applied amount of the first silane compound is more preferably from 1.9 to 3.7 mg/m², and particularly preferably from 2.3 to 3.5 mg/m².

After the primer layer composition is applied, the first silane compound is reacted. Specifically, the first silane compound is reacted by heating the composition for primer layer in the form of a coating film. The heating temperature is preferably from 80 to 120° C., and preferably from 90 to 120° C. Prior to the reaction, the first solvent is removed by drying, e.g., heating, if necessary. The heating for the reaction of the first silane compound and the drying (heating) for the removal of the first solvent may be performed simultaneously.

### (II) Antifouling Layer-Forming Step

In the antifouling layer-forming step, an antifouling layer is obtained by depositing the composition for antifouling layer containing the second silane compound on the primer layer and then reacting the second silane compound. The method of depositing the composition for antifouling layer on the primer layer may be the following dry coating or wet coating method.

When the second silane compound is blended in the composition for antifouling layer, the second silane compound may be blended as it is or may be blended as an oligomer thereof (partially hydrolyzed condensate). Alternatively, it may be blended in the composition for primer layer as a mixture of the second silane compound and its oligomer.

When at least two types of the second silane compound are used in combination, each compound may be blended in the composition for primer layer as it is, each may be blended as an oligomer thereof, or may be blended as a co-oligomer (partially hydrolyzed co-condensate) of at least two types of the compound.

It may also be a mixture of such a compound, oligomer (partially hydrolyzed condensate), and co-oligomer (partially hydrolyzed co-condensate). The oligomer and co-oligomer also have hydrolyzable groups, including hydrolyzed silanol groups, and a perfluoropolyether groups. Hereinafter, the term “the composition for antifouling layer contains the second silane compound” means that the composition for antifouling layer contains such an oligomer or co-oligomer as well as the first silane compound itself.

### Dry Coating Method

In the dry coating method, the composition for antifouling layer for use in dry coating, which contains a component for forming the antifouling layer, i.e., a component containing the second silane compound and an optional component for the antifouling layer, can be used as it is. The composition for antifouling layer for use in dry coating may consist only of the second silane compound.

The dry coating method may be a method such as vacuum vapor deposition, CVD, or sputtering. From the viewpoint of suppressing decomposition of the second silane compound and of simplicity of apparatuses, the vacuum vapor deposition can be preferably used. The vacuum vapor deposition method can be classified into a resistance heating method, an electron beam heating method, a high-frequency induction heating method, a reactive evaporation method, a molecular beam epitaxy method, a hot wall evaporation method, an ion plating method, a cluster ion beam method, or the like, and any method can be applicable. From the viewpoint of suppressing decomposition of the second silane compound and of simplicity of apparatuses, the resistive heating method can be preferably used. The vacuum vapor deposition apparatus is not particularly limited, but a known apparatus can be used.

The condition for film formation in the case of using the vacuum vapor deposition method varies depending on the type of the vacuum vapor deposition method to be applied. However, in the case of the resistive heating method, the pre-evaporation vacuum degree is preferably at most 1×10⁻² Pa, particularly preferably at most 1×10⁻³ Pa. The heating temperature of the vapor deposition source is not particularly limited as long as the vapor deposition source (the composition for antifouling layer for use in dry coating) has a sufficient vapor pressure. Specifically, the heating temperature is preferably from 30 to 400° C., particularly preferably from 50 to 300° C.

When the heating temperature is at least the lower limit value in the above range, the film formation rate becomes good. If it is at most the upper limit value in the above range, initial water-, and oil-repellency, and fouling-removing properties can be imparted to the surface of the organic material of the substrate without decomposition of the second silane compound. During vacuum vapor deposition, the temperature of the substrate is in a range of preferably from a room temperature (from 20 to 25° C.) to the heat-resistant temperature of the organic material on the surface of the substrate. When the temperature of the substrate is at most the above-mentioned heat-resistant temperature, the film formation rate becomes good. The upper limit value of the temperature of the substrate is more preferably at most the heat-resistant temperature minus 50° C.

In the dry coating method, it is preferred to deposit the composition for antifouling layer on the primer layer so that the deposited amount of the second silane compound is from 30 to 80 mg/m², in order to make the preferred thickness of the obtained antifouling layer as described above. The deposited amount of the second silane compound is more preferably from 35 to 80 mg/m², particularly preferably from 55 to 70 mg/m².

In the dry coating method, the reaction of the second silane compound proceeds substantially simultaneously by adjusting the substrate temperature during the film formation in a manner as described above. At this time, some of silanol groups generated from hydrolyzable silyl groups of the second silane compound by means of a hydrolysis reaction are condensed to be bonded intermolecularly. The silanol groups generated from the second silane compound are condensed with silanol groups generated from the first silane compound of the primer layer, whereby the primer layer and the antifouling layer are bonded by siloxane bonds. By performing a post- treatment step, which is an optional step described later, a strong bond is formed by the antifouling layer.

### Wet Coating Method

In the wet coating method, a composition for antifouling layer for use in wet coating (hereinafter, also referred to as “coating liquid”) containing the second solvent and the composition for antifouling layer for use in dry coating, is prepared.

In the wet coating method, the coating liquid is applied to the surface of the primer layer, and then the second silane compound is reacted to form the antifouling layer.

As a method of applying the coating liquid, a known method can be used as appropriate. The applying method may specifically be a method similar to the application method of the composition for primer layer, including the preferred embodiment. The applied amount of the coating liquid can be similar to the deposited amount of the second silane compound in the case of the above-mentioned dry coating method, including the preferred embodiment.

After the coating liquid is applied, the second silane compound is reacted. Specifically, the second silane compound is reacted by leaving the coating liquid in the form of a coating film at a predetermined reaction temperature for a predetermined time. The reaction temperature is in a range of preferably from 10° C. to the heat-resistant temperature of the organic material on the surface of the substrate, more preferably from 20° C. to the heat-resistant temperature of the organic material on surface of the substrate. The upper limit value is more preferably at most the heat-resistant temperature of the organic material on the surface of the substrate minus 50° C. Prior to the reaction, the second solvent is removed by drying if necessary. The reaction of the second silane compound and the drying for removal of the second solvent may be carried out simultaneously.

The reaction of the second silane compound in the wet coating method is similar to that in the dry coating method. Similarly to the dry coating method, a post-treatment step, which is an optional step described later, is performed, whereby a strong bond is formed by the antifouling layer.

### Coating Solution

The composition for antifouling layer for use in wet coating, which is used for the wet coating method, contains the second silane compound and the second solvent. The coating liquid may contain the second silane compound as a solid component, and may contain an impurity such as a by-product generated in the production method of the compound in the above proportion. Further, the above-mentioned optional solid component may be contained in the above-mentioned proportion.

The second solvent is preferably in a liquid form. The coating liquid may be in a liquid form, i.e., it may be a solution or a dispersion.

The content proportion of the second silane compound in the coating liquid is preferably from 0.001 to 30 mass %, particularly preferably from 0.1 to 20 mass %, to the total amount of the coating liquid.

Further, for example, the proportion of the second silane compound to the total amount of the coating liquid can be as follows, as necessary.

From 0.001 to 0.01 mass %, from 0.01 to 0.03 mass %, from 0.03 to 0.05 mass %, from 0.05 to 0.1 mass %, from 0.1 to 0.2 mass %, from 0.2 to 0.5 mass %, from 0.5 to 1 mass %, from 1 to 2 mass %, from 2 to 5 mass %, from 5 to 10 mass %, from 10 to 15 mass %, from 15 to 20 mass %, from 20 to 25 mass %, or from 25 to 30 mass %.

### Second Solvent

The second solvent may be preferably an organic solvent. The organic solvent may be a fluorinated organic solvent, may be a non-fluorinated organic solvent, or may contain the both solvents. The second solvent may be one kind of compound or a mixture of at least two kinds.

The fluorinated organic solvent may be a fluorinated alkane, a fluorinated alkene, a fluorinated aromatic compound, a fluoroalkyl ether, a fluorinated alkylamine, a fluoroalcohol, or the like.

The fluorinated alkane may be preferably a compound having 4 to 8 carbon atoms. A commercially available product may, for example, be C₆F₁₃H (AC-2000: product name, manufactured by Asahi Glass Company, Limited), C₆F₁₃C₂H₅ (AC-6000: product name, manufactured by Asahi Glass Company, Limited), C₂F₅CHFCHFCF₃ (Bartrell: product name, manufactured by DuPont Company), or the like. In addition, 1,1,1,3,3-pentafluorobutane, 1,1,1,2,2,3,4,5,5,5-decafluoropentane, 1,1,2,2,3,3,4-heptafluorocyclopentane, 1,1,1,2,2,3,3,4,4-nonafluorohexane, or the like may also be used.

The fluorinated alkene may be (E)-1-chloro-3,3,3-trifluoro-1-propene, (Z)-1-chloro-3,3,3-trifluoro-1-propene, 1,1-dichloro-2,3,3-tetrafluoro-1-propene, (E)-1-chloro-2,3,3,3-tetrafluoro-1-propene, (Z)-1-chloro-2,3,3,3-tetrafluoro-1-propene, (Z)-1,1,1,4,4,4-hexafluoro-2-butene, (E)-1,1,1,4,4,4-hexafluoro-2-butene, an alkyl perfluoroalkenyl ether represented by each of the following formulae (wherein R³ can be either CH₃ or C₂H₅, y1 and y2 are independently 0, 1, 2 or 3, y1+y2=0, 1, 2 or 3), or a mixture thereof, or the like.

CF₃(CF₂)_{y1}CF═CFCF(OR³)(CF₂)_{y2}CF₃,

CF₃(CF₂)_{y1}C(OR³)═CFCF₂(CF₂)_{y2}CF₃,

CF₃CF═CFCF(OR³)(CF₂)_{y1}(CF₂)_{y2}CF₃,

CF₃(CF₂)_{y1}CF═C(OR³)CF₂(CF₂)_{y2}CF.

The fluorinated aromatic compound may be hexafluorobenzene, trifluoromethylbenzene, perfluorotoluene, ortho-bis(trifluoromethyl)benzene, meta-bis(trifluoromethyl)benzene, para-bis(trifluoromethyl)benzene, or the like.

The fluoroalkyl ether may be preferably a compound having 4 to 12 carbon atoms. A commercially available product may, for example, be CF₃CH₂OCF₂CF₂H (AE-3000: product name, manufactured by Asahi Glass Company, Limited), C₄F₉OCH₃ (Noveq-7100: product name, manufactured by 3M Company), C₄F₉OC₂H₅ (Noveq-7200: product name, manufactured by 3M Company), C₆F₁₃OCH₃ (Noveq-7300: product name, manufactured by 3M Company), perfluoro(2-butyltetrahydrofuran), or the like.

The fluorinated alkylamine may, for example, be perfluorotripropylamine, perfluorotributylamine, perfluorotripentylamine, or the like.

The fluoroalcohol may, for example, be 2,2,3,3-tetrafluoropropanol, 2,2,2-trifluoroethanol, hexafluoroisopropanol, or the like.

The fluorinated organic solvent may be preferably a fluorinated alkane, a fluorinated aromatic compound, or a fluoroalkyl ether, particularly preferably a fluoroalkyl ether from the viewpoint of solubility of the second silane compound.

The non-fluorinated organic solvent may be preferably a compound composed only of hydrogen atoms and/or chlorine atoms and carbon atoms, or a compound composed only of hydrogen atoms, carbon atoms and oxygen atoms. A hydrocarbon- type organic solvent, an alcohol-type organic solvent, a ketone-type organic solvent, an ether-type organic solvent, an ester-type organic solvent, or a chlorine-type solvent may be mentioned.

The hydrocarbon-type organic solvent may be preferably hexane, heptane, cyclohexane, petroleum benzine, toluene, xylene, or the like.

The alcohol-type organic solvent may be preferably methanol, ethanol, propanol, isopropanol, or the like.

The ketone-type organic solvent may be preferably acetone, methyl ethyl ketone, methyl isobutyl ketone, or the like.

The ether-type organic solvent may be preferably diethyl ether, tetrahydrofuran, tetraethylene glycol dimethyl ether, or the like.

The ester organic solvent may be preferably ethyl acetate, butyl acetate, or the like.

The chlorine-type solvent may be preferably 1,1-dichloroethane, 1,2-dichloroethane, 1,1,2-trichloroethane, 1,1,1,2-tetrachloroethane, 1,1,2,2-tetrachloroethane,pentachloroethane, 1,1-dichloroethylene, (Z)-1,2-dichloroethylene, (E)-1,2-dichloroethylene, trichloroethylene, tetrachloroethylene, chloroform, carbon tetrachloride, dichloromethane, or the like.

The non-fluorinated organic solvent may be particularly preferably a ketone-type organic solvent from the viewpoint of solubility of the second silane compound.

The second solvent may be preferably at least one organic solvent selected from the group consisting of a fluorinated alkane, a fluorinated aromatic compound, a fluoroalkyl ether, a compound consisting only of hydrogen atoms and/or chlorine atoms and carbon atoms, and a compound consisting only of hydrogen atoms, carbon atoms and oxygen atoms, from the viewpoint of enhancing the solubility of the second silane compound. A fluorinated organic solvent selected from a fluorinated alkane, a fluorinated aromatic compound, and a fluoroalkyl ether is particularly preferred.

As the second solvent, it is preferred that at least one organic solvent selected from the group consisting of a fluorinated organic solvent being a fluorinated alkane, a fluorinated aromatic compound, or a fluoroalkyl ether, and a non-fluorinated organic solvent selected from a compound consisting of only hydrogen atoms, carbon atoms and oxygen atoms, is contained in an amount of at least 90 mass % to the entire second solvent, from the viewpoint of enhancing the solubility of the second silane compound.

The coating liquid contains preferably from 70 to 99.999 mass % of the second solvent, and particularly preferably from 80 to 99.99 mass % of the second solvent, to the total amount of the coating liquid. The second solvent may specifically be C₆F₁₃C₂H₅ (AC-6000: product name, manufactured by Asahi Glass Company, Limited), CF₃CH₂OCF₂CF₂H (AE-3000: product name, manufactured by Asahi Glass Company, Limited), C₄F₉OCH₃ (Noveq-7100: product name, manufactured by 3M Company), C₄F₉OC₂H₅ (Noveq-7200: product name, manufactured by 3M Company), or C₆F₁₃OCH₃ (Noveq-7300: product name, manufactured by 3M Company). Such a solvent may be used alone or as a mixture thereof. The mixture may, for example, be the following combination having the following product name:

Any combination may be used, such as a combination of AC-6000 and AE-3000, a combination of AC-6000 and Knovek-7100, a combination of AC-6000 and Knovek-7200, a combination of AC-6000 and Knovek-7300, a combination of AE-3000 and Knovek-7100, a combination of AE-3000 and Knovek-7200, a combination of AE-3000 and Knovek-7300, a combination of AC-6000 and AE-3000 and Knovek-7100, a combination of AC-6000 and AE-3000 and Knovek-7200, a combination of AC-6000 and AE-3000 and Knovek-7300, a combination of AE-3000 and isopropanol, or a combination of AC-6000 and isopropanol.

When AC-6000 and AE-3000 are used in combination, the proportion of AE-3000 to the total amount of AC-6000 and AE-3000 is preferably from 5 mass % to 20 mass %.

When a combination of AC-6000, a AE-3000, and Noveq-7100 is used, the proportion of AE-3000 to the total amount of AC-6000, a AE-3000, and a Noveq-7100 is preferably from 0.05 mass % to 0.15 mass %, and the proportion of Noveq-7100 is preferably from 95 mass % to 99.5 mass %.

When a combination of AC-6000, a AE-3000, and Noveq-7200 is used, the proportion of AE-3000 to the total amount of AC-6000, a AE-3000, and a Noveq-7200 is preferably form 0.05 mass % to 0.15 mass %, and the proportion of Noveq-7200 is preferably from 95 mass % to 99.5 mass %.

When the combination of AC-6000, the AE-3000 and the Noveq-7300 is used, the proportion of AE-3000 to the total amount of AC-6000, the AE-3000 and the Noveq-7300 is preferably from 0.05 mass % to 0.15 mass %, and the proportion of the Noveq-7300 is preferably from 95 mass % to 99.5 mass %.

When AE-3000 and isopropanol are used in combination, the proportion of AE-3000 to the total amount of AE-3000 and isopropanol is preferably from 50 mass % to 90 mass %.

When AC-6000 and isopropanol are used in combination, the proportion of AC-6000 to the total amount of AC-6000 and isopropanol is preferably from 50 mass % to 90 mass %.

The coating liquid may further contain another component as long as the effect of the coating liquid is not impaired. Another component may, for example, be a known additive such as an acid catalyst and basic catalyst that promote hydrolysis and condensation reactions of the hydrolyzable silyl group. The acid catalyst and the basic catalyst may, for example, be a compound similar to that described in the composition for primer layer. The content of another component in the coating liquid is preferably at most 10 mass %, particularly preferably at most 1 mass %.

The proportion of the solid content (solid content concentration) in the coating liquid is preferably from 0.001 to 30 mass %, particularly preferably from 0.01 to 20 mass %. The solid content concentration in the coating liquid is a value calculated from the mass of the coating liquid before heating and the mass after heating in a convection dryer at 120° C. for 4 hours.

### Method for Producing Coating Liquid

The coating liquid can be prepared by mixing the second silane compound and the second solvent and an optional ingredient in a suitable mixing vessel. Prior to mixing, the second solvent may be used after water or a metallic component in the second solvent is adsorbed by an adsorbent such as activated carbon, zeolite, silica, or alumina. One adsorbent may be used alone, or at least two adsorbents may be used in combination. In particular, when water is adsorbed, it is preferred to use zeolite. The amount of water in the second solvent can be measured by a Karl Fisher moisture meter or the like. The amount of water is preferably at most 50 ppm, more preferably at most 20 ppm, particularly preferably at most 10 ppm. If the amount of water is at most the upper limit value, the second silane compound is prevented from reacting with one another, and the reactivity of the coating liquid can be kept long.

Alternatively, after the second silane compound, the second solvent, and the optional component are mixed, the coating liquid may be contacted with the adsorbent to remove water. The amount of water in the coating liquid is preferably at most 50 ppm, more preferably at most 20 ppm, particularly preferably at most 10 ppm.

The method of adding the second silane compound, the second solvent, and the optional component to a mixing vessel may be in either a batch or a continuous mode. In the case of adding in a batch mode, the order of adding the respective components is not particularly limited. The respective components may be added at the same time. The material of the mixing vessel may be a metal, a resin, or glass. Specifically, a metal such as SUS, iron, tin, hastelloy, nickel, or aluminum, or a resin such as polypropylene, polytetrafluoroethylene (PTFE), a copolymer of tetrafluoroethylene and perfluoroalkyl vinyl ether (PFA), or polyethylene, may be mentioned. A container in which the inside of a metal container is lined with glass or a resin, may be used.

### Zeolite

The zeolite is a synthetic zeolite having a chemical composition represented by the following chemical formula (Z1) or (Z2).

KₓNa_{y}[(AlO₂)₁₂(SiO₂)₁₂]·27H₂O (Z1)

(where x+y=12 and x:y=from 4:6 to 8:2)

KₓNa_{y}[(AlO₂)₈₆(SiO₂)₁₀₆]·276H₂O (Z2)

(where x+y=86 and x:y=from 4:6 to 8:2)

The zeolite used for the present invention may, for example, be Zeolite 3A, 4A, or 5A. Zeolite 3A, 4A or 5A is a synthetic zeolite having a pore diameter of from 0.25 nm to 0.45 nm. A commercially available product may be Molecular sieve 3A, 4A or 5A (trade name of Union Showa Corporation). A type X zeolite may also be used. A commercial product of the type X zeolite may be Molecular sieve 13X, and Molecular sieve 13X may be used in combination with Zeolite 3A, 4A, or 5A. The pore diameter of the zeolite can be measured by a constant volume gas adsorption method. The adsorption gas used in the constant volume gas adsorption method may be N₂, CO₂, CH₄, H₂, Ar, or the like.

### (IIa) Post-Treatment Step

The step (IIa) is a post-treatment step performed on the antifouling layer after the antifouling layer is formed on the surface of the primer layer by the dry coating method or the wet coating method.

The post-treatment may be an operation for promoting the reaction between the second silane compound and the primer layer, which is performed to improve the abrasion durability of the antifouling layer. Such an operation may be heating, humidification, light irradiation, or the like. For example, the following reaction can be promoted by heating the substrate in which the primer layer and the antifouling layer are formed in this order on the surface of the organic material: a hydrolysis reaction in which hydrolyzable silyl groups of the second silane compound are hydrolyzed to silanol groups, a condensation reaction of silanol groups on the surface of the primer layer and silanols group generated from the second silane compound, or formation of siloxane bonds by a condensation reaction of silanol groups generated from the second silane compound.

After forming the antifouling layer, a compound in the antifouling layer that is not chemically bonded to another compound or the primer layer may be removed as necessary. The specific method may, for example, be a method of flushing the antifouling layer with a solvent (for example, the second solvent), or a method of wiping the antifouling layer with a cloth impregnated with a solvent (for example, the second solvent).

### EXAMPLES

In Examples, the composition for primer layer and the composition for antifouling layer for use in wet coating were prepared, and the obtained composition was used to form the primer layer and the antifouling layer in this order on a main surface of a plate- shaped or film-shaped resin substrate, followed by evaluations. Ex. 1 to 4, 6 and 8 are Examples of the present invention, and Ex. 5, 7 and 9 are Comparative Examples. In Comparative examples, no primer layer was formed.

The material or raw material compound constituting each component and the SP value thereof are shown below. In the following description, the unit of the SP value ((J/cm³)^{1/2}) is omitted.

### Substrate

PMMA substrate (plate thickness; 1 mm); manufactured by Mitsubishi Rayon Corporation, Acrylite (registered trademark) (SPₒₘ; 19.4)

PC substrate (plate thickness: 1 mm); manufactured by Azone Corporation, Transparent PC2-9224-01 (trade name) (SPₒₘ; 20.2)

PET Film (thickness: 200 μm); manufactured by Toyobo Corporation, Ester (registered trademark) film (SPₒₘ; 21.9)

### First Silane Compound

Aminosilane 1: A hydrolyzed condensate of an amino group-containing silane compound (An aqueous solution having a solid content of 32 mass %, manufactured by Shin-Etsu Chemical Corporation, KBP-90 (trade name), SP_{fg}; 20.3, SP_{OH}; 35.1)

Aminosilane 2; 3-aminopropyltriethoxysilane (Shin-Etsu Chemical Corporation, KBE903 (trade name), SP_{fg}; 20.3, SP_{OH}; 35.1)

Methacrylsilane; 3-methacryloxypropyltrimethoxysilane (Shin-Etsu Chemical Corporation, KBM503 (trade name), SP_{fg}; 19.4, SP_{OH}; 30.8)

Epoxysilane; 3-glycidoxypropyltrimethoxysilane (Shin-Etsu Chemical Corporation, KBM403 (trade name), SP_{fg}; 19.0, SP_{OH}; 34.2)

### Second Silane Compound

The following compound corresponding to the silane compound (A1) was prepared by the method described in WO2013/121984, and used as the second silane compound.

CF₃—O—(CF₂CF₂O—CF₂CF₂CF₂CF₂O)ₙ—CF₂CF₂OCF₂CF₂CF₂C(═O)NH(CH₂)₃—Si(OCH₃)₃ (n=14)

### Preparation of Composition for Primer Layer

Each of the above first silane compounds was mixed with isopropanol (manufactured by Central Glass Corporation) (SPₛᵥ; 23.5) to prepare the composition for primer layer in which the content proportion of the first silane compound to the total amount of the composition is 0.1 mass %.

### Preparation of Composition for Antifouling Layer

The above second silane compound was mixed with AC-6000 (product name, manufactured by Asahi Glass Company, Limited) to prepare the composition for antifouling layer for use in wet coating in which the content proportion of the second silane compound to the total amount of the composition is 0.1 mass %.

### Ex. 1 to 5

### Activation Treatment of Substrate

The above-mentioned PC substrate was cleaned with an alkaline aqueous solution (product name: Sika Clean LX-IV, manufactured by Kanto Chemical Company, density: 10 mass %), further cleaned with ion exchanged water, and then subjected to corona treatment to impart wettability to both main surfaces of the PC substrate. The corona treatment was performed by passing the PC substrate between both electrodes in a corona discharge with a discharge quantity of 80 W-min/m² in a state where the PC substrate is electrically floated so that the distance between each electrode and the main surface of the PC substrate was from 1 mm to 2 mm.

### Primer Layer-Forming Step

In Ex. 1 to 4, each of the compositions for primer layer prepared as described above (see Table 4) was applied to one main surface of the PC substrate after the corona treatment by a spin-coating method (applied amount: 3.0 mg/m²), and heated on a hot plate at 100° C. for 90 seconds to dry and remove isopropanol, and to react the first silane compound to form a primer layer having a thickness of 5 nm.

### Antifouling Layer-Forming Step

The composition for antifouling layer prepared as described above was applied on the primer layer of the PC substrate on which the primer layer had been formed, by a spraying method (applied amount: 64 mg/m²), and heated in a hot air circulating oven at 120° C. for 10 minutes to dry and remove AC-6000, and to react the second silane compound to form a antifouling layer having a thickness of 15 nm, thereby obtaining the antifouling articles of Ex. 1 to 4. In Ex. 5, the antifouling layer having a thickness of 15 nm was formed on one main surface of the PC substrate after the corona treatment without forming the primer layer, thereby obtaining the antifouling article.

### Ex. 6 and 7

The antifouling article of Ex. 6 was obtained in the same manner as in Ex. 1 except that the substrate was replaced with the PMMA substrate. In addition, the PMMA substrate of Ex. 7 was obtained by subjecting the PMMA substrate to the corona treatment in the same manner as in Ex. 6, and then forming the antifouling layer having a thickness of 15 nm on one main surface of the PMMA substrate after the corona treatment without forming the primer layer.

### Ex. 8 and 9

The antifouling article of Ex. 8 was obtained in the same manner as in Ex. 1 except that the substrate was replaced with the PET film. In addition, the antifouling article of Ex. 9 was obtained by subjecting the PET film to the corona treatment in the same manner as in Ex. 8, and then forming the antifouling layer having a thickness of 15 nm on one main surface of the PET film after the corona treatment without forming the primer layer.

### Evaluations

### Method of Measuring Water Contact Angle

For each of the antifouling articles of Ex. 1 to 9 obtained as described above, the contact angle of about 2 μl of distilled water placed on the antifouling layer was measured using a contact angle measuring device DM-500 (manufactured by Kyowa Interface Scientific Company). Measurements were made at five different points on the surface of the antifouling layer, and the average value was calculated. A 28 method was used to calculate the contact angle. When the water contact angle is at least 100°, it can be said that the antifouling property is sufficient for practical use.

### Abrasion Resistant Evaluation

A reciprocating flat abrasion tester (PA-300A manufactured by Daiei Seiki Co., Ltd.) was used in accordance with JIS L 0849: 2013 (ISO 105-X12: 2001). The gold width (No. 30) was subjected to reciprocating abrasion at a load of 1 kg/cm² (Ex. 1 to 5, 8, and 9), 200 g/cm² (Ex. 6 and 7), a velocity of 60 rpm, and an amplitude of 40 mm, and then the water contact angle was measured every predetermined number of times. The test was terminated when the water contact angle become at most 100°.

The results are shown in Table 4 for Ex. 1 to 5, Table 5 for Ex. 6 and 7, and Table 6 for Ex. 8 and 9. The respective tables also show the relation between the SP value of the compound contained in the composition for primer layer and the organic material of the substrate, |SP_{fg}−SPₒₘ|, |SPₛᵥ−SP_{OH}|, and |SPₛᵥ−SPₒₘ|. In the results of the water contact angle in the tables, the expression “-” indicates that no measurement was performed. In the tables, a slanting line indicates that the abrasion resistance test was not performed.

TABLE 4

| Ex. | | 1 | 2 | 3 | 4 | 5 |
|---|---|---|---|---|---|---|
| Substrate | | PC | PC | PC | PC | PC |
| Primer layer (First | | Amino- | Amino- | Methacrylic | Epoxy | No |
| silane compound) | | silane 1 | silane 2 | silane | silane | primer |
| Absolute value | \|SP_{fg}-SPₒₘ\| | 0.1 | 0.1 | 0.8 | 1.2 | — |
| of difference | \|SPₛᵥ-SP_{OH}\| | 11.6 | 11.6 | 7.3 | 10.7 | — |
| between SP values | \|SPₛᵥ-SPₒₘ\| | 3.3 | 3.3 | 3.3 | 3.3 | — |
| (J/cm³)^{1/2} | | | | | | |
| Water | Initial (0 time) | 112.5 | 112.1 | 111.7 | 112.0 | 113.6 |
| contact | 1,000 times | — | — | — | — | 93.8 |
| angle (°) | 6,000 times | 104.9 | 102.9 | 103.8 | 103.8 | |
| | 8,000 times | 86.4 | 94.8 | 102.1 | 102.1 | |
| | 10,000 times | | | 99.3 | 86.7 | |

TABLE 5

| | | Ex. | |
|---|---|---|---|
| | | 6 | 7 |
| Substrate | | PMMA | PMMA |
| Primer layer (First silane compound) | | Aminosilane 1 | No primer |
| Absolute value of | \|SP_{fg} − SPₒₘ\| | 0.9 | — |
| difference between SP | \|SPₛᵥ − SP_{OH}\| | 11.6 | — |
| values (J/cm³)^{1/2} | \|SPₛᵥ − SPₒₘ\| | 4.1 | — |
| Water contact angle (°) | Initial (0 time) | 112.5 | 105.1 |
| | 1,000 times | 108.1 | 97.0 |
| | 5,000 times | 102.0 | |
| | 6,000 times | 99.5 | |

TABLE 6

| | | Ex. | |
|---|---|---|---|
| | | 8 | 9 |
| Substrate | | PET | PET |
| Primer layer (First silane compound) | | Aminosilane 1 | No |
| | | | primer |
| Absolute value of difference | \|SP_{fg} − SPₒₘ\| | 1.6 | — |
| between SP values | \|SPₛᵥ − SP_{OH}\| | 11.6 | — |
| (J/cm³)^{1/2} | \|SPₛᵥ − SPₒₘ\| | 1.6 | — |
| Water contact angle (°) | Initial (0 time) | 112.1 | 109.0 |
| | 50 times | — | 98.7 |
| | 100 times | — | |
| | 500 times | — | |
| | 6,000 times | 109.5 | |
| | 16,000 times | 108.4 | |

### INDUSTRIAL APPLICABILITY

According to the present invention, in the antifouling article comprising an antifouling layer formed on the surface of an organic material by using a fluorinated compound, the antifouling article is excellent in the antifouling property and has durability such as abrasion resistance with respect to the antifouling property. The antifouling article can be used, for example, as an antireflection film, a protective film for a display, a fingerprint sensor, a member for a portable terminal, a floor material, or the like.

This application is a continuation of PCT Application No. PCT/JP2018/017907, filed on May 9, 2018, which is based upon and claims the benefit of priority from Japanese Patent Application No. 2017-095747 filed on May 12, 2017. The contents of those applications are incorporated herein by reference in their entireties.

What is claimed is:

1. An antifouling article comprising:
a substrate, at least a portion of the surface thereof being made of an organic material;
a primer layer disposed on the surface made of the organic material; and
an antifouling layer disposed on the primer layer; wherein:
the primer layer is a layer formed by using a first silane compound which has a hydrolyzable silyl group and a reactive organic group;
the reactive organic group is a group having a linking group and a reactive group, or a reactive group other than a hydrolyzable group;
the absolute value of the difference between the SP value of the organic material and the SP value of the reactive organic group is from 0 to 3.0 (J/cm³)^{1/2}; and
the antifouling layer is a layer formed by using a second silane compound having a perfluoropolyether group and a hydrolyzable silyl group.

2. The antifouling article according to claim 1, wherein the thickness of the primer layer is from 5 to 100 nm.

3. The antifouling article according to claim 1, wherein the thickness of the antifouling layer is from 10 to 100 nm.

4. The antifouling article according to claim 1, wherein the reactive organic group is a group having at least one reactive group selected from a vinyl group, an epoxy group, a (meth)acryloxy group, an amino group, an isocyanate group, and a mercapto group.

5. The antifouling article according to claim 1, wherein the first silane compound is at least one member selected from 3-aminopropyltriethoxysilane, 3-methacryloxypropyltrimethoxysilane, and 3-glycidoxypropyltrimethoxysilane.

6. The antifouling article according to claim 1, wherein the second silane compound is a silane compound which has a poly(oxyperfluoroalkylene) chain represented by —(CₐF₂ₐO)_{b}— (wherein a is an integer of from 1 to 6, b is an integer of at least 2, and it may have at least two —CₐF₂ₐO— units different in the number of carbon atoms), and which has a hydrolyzable silyl group via a linking group at at least one terminal of the poly(oxyperfluoroalkylene) chain.

7. The antifouling article according to claim 1, wherein the organic material contains at least one member selected from a resin and an elastomer.

8. A method for producing an antifouling article comprising:
a substrate, at least a portion of the surface thereof being made of an organic material;
a primer layer disposed on the surface made of the organic material; and
an antifouling layer disposed on the primer layer;
wherein the method comprises:
applying, onto the surface made of the organic material, a composition for primer layer comprising a first silane compound and a first solvent, wherein the first silane compound has a hydrolyzable silyl group and a reactive organic group; the reactive organic group is a group having a linking group and a reactive group, or a reactive group other than a hydrolyzable group; and the absolute value of the difference between the SP value of the organic material and the SP value of the reactive organic group is from 0 to 3.0 (J/cm³)^{1/2}; and then reacting the first silane compound to obtain the primer layer; and
depositing, on the primer layer, a composition for antifouling layer comprising a second silane compound having a perfluoropolyether group and a hydrolyzable silyl group; and then reacting the second silane compound to obtain the antifouling layer.

9. The production method according to claim 8, wherein the absolute value of the difference between the SP value in the case where the hydrolyzable silyl group of the first silane compound is a silanol group and the SP value of the first solvent is from 0 to 12.0 (J/cm³)^{1/2}.

10. The production method according to claim 8, wherein the absolute value of the difference between the SP value of the first solvent and the SP value of the organic material is from 0 to 5.0 (J/cm³)^{1/2}.

11. The production method according to claim 8, wherein the composition for primer layer is applied so that the applied amount of the first silane compound be from 1.0 to 4.0 mg/m².

12. The production method according to claim 8, wherein the first silane compound is contained in a proportion of from 0.01 to 5.0 mass % to the total amount of the composition for primer layer.

13. The production method according to claim 8, wherein the reactive organic group is a group having at least one reactive group selected from a vinyl group, an epoxy group, a (meth)acryloxy group, an amino group, an isocyanate group, and a mercapto group.

14. The production method according to claim 8, wherein the first silane compound is at least one member selected from 3-aminopropyltriethoxysilane, 3-methacryloxypropyltrimethoxysilane and 3-glycidoxypropyltrimethoxysilane.

15. The production method according to claim 8, wherein the second silane compound is a silane compound which has a poly(oxyperfluoroalkylene) chain represented by —(CₐF₂ₐO)_{b}— (wherein a is an integer of from 1 to 6, b is an integer of at least 2, and it may have at least two —CₐF₂ₐO— units different in the number of carbon atoms), and which has a hydrolyzable silyl group via a linking group at at least one terminal of the poly(oxyperfluoroalkylene) chain.

16. The production method according to claim 8, wherein the composition for antifouling layer is deposited so that the deposited amount of the second silane compound be from 30 to 80 mg/m².

17. The production method according to claim 8, wherein the composition for antifouling layer further contains a second solvent, and the composition for antifouling layer is applied onto the primer layer.

18. The production method according to claim 17, wherein the second silane compound is contained in a proportion of from 0.001 to 30 mass % to the total amount of the composition for antifouling layer.

19. The production method according to claim 8, wherein the organic material contains at least one member selected from a resin and an elastomer.
